(19) United States
(12) Patent Application Publication
(10) Pub. No.: US 2019/0300449 A1
(43) Pub. Date: Oct. 3, 2019

(54) SOLAR-REFLECTIVE ROOFING GRANULES, ROOFING PRODUCTS INCLUDING THEM, AND METHODS FOR MAKING THE GRANULES AND ROOFING PRODUCTS

(71) Applicant: CertainTeed Corporation, Malvern, PA (US)

(72) Inventors: Tracy H. Panzarella, Norwood, MA (US); Rachel Z. Pytel, Newton, MA (US); Simon Mazoyer, Paris (FR)

(21) Appl. No.: 16/370,549

(22) Filed: Mar. 29, 2019

Related U.S. Application Data
(60) Provisional application No. 62/651,100, filed on Mar. 31, 2018.

(51) Int. Cl. C04B 41/45; C04B 26/26; C04B 41/00; C04B 41/50; C04B 41/65; C04B 35/626; C04B 35/628; E04D 1/20

(52) U.S. Cl. CPC C04B 41/4545; C04B 26/26; C04B 41/009; C04B 41/5025; C04B 2103/54; C04B 35/62695; C04B 35/62802; E04D 1/20; C04B 41/65

(57) ABSTRACT

The present disclosure relates more particularly to roofing granules, such as solar-reflective roofing granules, and to methods for making and using them in roofing products. Provided are, for example, a collection of solar-reflective roofing granules having a solar reflectivity of at least 70%, (e.g., at least 80 wt % or even at least 90 wt %) of the solar-reflective roofing granules of the collection having a major aspect ratio of at least 4 and a minor aspect ratio of at least 3. Also provided is a roofing product that includes a substrate; a bituminous material coated on the substrate, the bituminous material having a top surface; and a collection of solar-reflective roofing granules as described herein disposed on the top surface of the bituminous material, thereby substantially coating the bituminous material in a region thereof.

### CROSS-REFERENCE TO RELATED APPLICATIONS

This application claims the benefit of priority of U.S. Provisional Patent Application No. 62/651,100, filed Mar. 31, 2018.

### BACKGROUND OF THE DISCLOSURE

### 1. Field of the Disclosure

The present disclosure relates generally to roofing products. The present disclosure relates more particularly to roofing granules, such as solar-reflective roofing granules, and to methods for making and using them in roofing products.

### 2. Technical Background

Sized mineral rocks are commonly used as granules in roofing applications to provide protective functions to the asphalt shingles. Roofing granules are generally used in asphalt shingles or in roofing membranes to protect asphalt from harmful ultraviolet radiation. Roofing granules typically comprise crushed and screened mineral materials, which can be coated subsequently with a binder containing one or more coloring pigments, such as suitable metal oxides. The granules are employed to provide a protective layer on asphaltic roofing materials such as shingles, and to add aesthetic values to a roof.

Depending on location and climate, shingled roofs can experience very challenging environmental conditions, which tend to reduce the effective service life of such roofs. One significant environmental stress is the elevated temperature to which roofing shingles are subjected under sunny, summer conditions.

Mineral-surfaced asphalt shingles, such as those described in ASTM D0225 or D03462, are generally used in steep-sloped roofs to enhance the water-shedding function while adding aesthetically pleasing appearance to the roofs. The asphalt shingles are generally constructed from asphalt-saturated roofing felts and surfaced by pigmented color granules, such as those described in U.S. Pat. No. 4,717,614. Asphalt shingles coated with conventional roofing granules are known to have low solar heat reflectivity, and hence will absorb solar heat, especially through the near infrared range (700 nm-2500 nm) of the solar spectrum. This phenomenon is increased as the granules covering the surface become dark in color. For example, while white-colored asphalt shingles can have solar reflectivity in the range of 25-35%, dark-colored asphalt shingles can have solar reflectivity of only 5-15%. Furthermore, except in the white or very light colors, there is typically only a very small amount of pigment in the color coating of the conventional granules that reflects solar radiation well. As a result, it is common to measure temperatures as high as 77° C. on the surface of black roofing shingles on a sunny day with 21° C. ambient temperature. Absorption of solar heat may result in elevated temperatures at the shingle's surroundings, which can contribute to the so-called “urban heat-island effect” and increase the cooling load to its surroundings. This not only increases the demand for indoor cooling energy, but also contributes to smog formation due to higher surface temperatures. Hence, it is beneficial to have a surface with increased solar reflectivity, such as greater than 70 percent, to reduce solar heat gain, thereby reducing the heat flux entering the building envelope or reducing surface temperatures for lowering smog formation. It is therefore advantageous to have roofing shingles that have high solar reflectivity.

The surface reflectivity of an asphalt shingle or roofing membrane largely depends on the solar reflectivity of the granules that are used to cover the bitumen. Typically, roofing granules are applied such that about 95 to 97 percent of the shingle surface is effectively covered by the granules.

The state of California has implemented a building code requiring the low-sloped roofs to have roof coverings with solar reflectivity greater than 70%. However, colored roofing granules, prepared using current coloring technology, are not generally capable of achieving such a high level of solar reflectivity. Thus, in order to reduce solar heat absorption, it has been suggested to apply coatings externally directly onto the shingled surface of roofs. White pigment-containing latex coatings have been proposed and evaluated by various manufacturers. However, the polymeric coating applied has only limited amount of service life and requires re-coat after certain years of service. Also, the cost of adding such a coating on roof coverings can be relatively high. Other manufactures have also proposed the use of exterior-grade coatings that were colored by IR-reflective pigments for deep-tone colors and sprayed onto the roof in the field.

Solar control films that contain either a thin layer of metal/metal oxides, or dielectric layers applied through vacuum deposition, have been commercially available for use in architectural glasses.

Many materials have been proposed for use in protecting roofing from solar heat radiation, such as ceramic grog, recycled porcelain, and white plastic chips. However, the previously proposed materials have limited use, and cannot satisfy all requirements for roofing materials. There is a continuing need for roofing materials, and especially asphalt shingles, that have improved resistance to thermal stresses. In particular, there is a need for roofing granules that provide increased solar heat reflectivity to reduce the solar absorption of the shingle. Hence, it would be advantageous to have a granular roofing product that has solar reflectivity greater than 70%.

### SUMMARY OF THE DISCLOSURE

In one aspect, the present disclosure provides a collection of solar-reflective roofing granules having a solar reflectivity of at least 70%, (e.g., at least 80 wt % or even at least 90 wt %) of the solar-reflective roofing granules of the collection having a major aspect ratio of at least 4 and a minor aspect ratio of at least 3.

In another aspect, the present disclosure provides a roofing product comprising
a substrate;
a bituminous material coated on the substrate, the bituminous material having a top surface; and
a collection of solar-reflective roofing granules as described herein disposed on the top surface of the bituminous material, thereby substantially coating the bituminous material in a region thereof.
   In certain such embodiments, each roofing granule has a major axis, a minor axis perpendicular to the major axis, and a thickness, and for at least 90% of the roofing granules having a major aspect ratio of at least 4 the major axis and the minor axis are disposed within 20 degrees of parallel to the major plane of the roofing product.

In another aspect, the present disclosure provides a method for making a roofing product as described herein, comprising
providing a substrate having a bituminous material disposed thereon, the bituminous material having a top surface, the top surface of the bituminous material being in a softened state; and
providing a collection of solar-reflective roofing granules as described herein;
orienting the solar-reflective roofing granules of the collection in a substantially single layer on a substantially upward-facing first, non-adhesive surface having a major plane such that for at least 90% of the roofing granules having a major aspect ratio of at least 4 the major axis and the minor axis are disposed within 20 degrees of parallel to the major plane of the first non-adhesive surface; and then
transferring the solar-reflective roofing granules of the collection to the top surface of the softened bituminous material without substantially changing the orientation of the solar-reflective roofing granules of the collection.

Another aspect of the disclosure provides a method for making a collection of solar-reflective roofing granules as described herein, the method comprising
providing a formable fireable preceramic material;
forming the preceramic material into a collection of preceramic particles having a high aspect ratio (e.g., by roll compaction); and
firing the collection of preceramic particles to provide a collection of granular particles having a high aspect ratio.
   The particles themselves can in some embodiments be the roofing granules of the collection, or in other embodiments can be coated to provide the roofing granules of the collection.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic view of a roofing granule suitable for use in the collections of roofing granules of the disclosure.

FIG. 2 is a cross-sectional schematic view of a coated solar-reflective roofing granule of the disclosure.

FIG. 3 is a cross-sectional schematic view of another solar-reflective roofing granule of the disclosure.

FIG. 4 is a schematic cross-sectional view of a roofing product according to one embodiment of the disclosure.

FIG. 5 is a schematic view of a method for making a roofing product according to one embodiment of the disclosure.

FIG. 6 is a schematic view of another method for making a roofing product according to one embodiment of the disclosure.

FIG. 7 is a schematic view of a method for using roll compaction to form granular particles.

FIG. 8 is a set of photographs showing staining of example shinglets.

FIG. 9 is a set of grayscale intensity maps, and FIG. 10 is a set of boundary skins for two example shingles using different size granules.

FIG. 11 is a graph of solar reflectivity and shingle roughness for a variety of shingles.

FIG. 12 is a full view and FIG. 13 is a detail view of a particle sorter;

FIG. 14 is graph showing the bin distribution of sorted granules using the particle sorter of FIG. 12 in a sorting experiment.

FIG. 15 is a set of pictures from two bins in the sorting experiment of FIG. 14.

FIG. 16 is graph showing solar reflectivities of granules from various bins from the sorting experiment of FIG. 14.

FIG. 17 is graph showing solar reflectivities of samples made from granules from various bins from the sorting experiment of FIG. 14.

FIG. 18 is a schematic view of a method to orient granules and to apply them to a bituminous material according to the disclosure.

FIG. 19 is a graph showing solar reflectivities for samples made from random and flattened oriented granules.

### DETAILED DESCRIPTION

The present inventors have noted that, while solar-reflective coatings and materials used in roofing granules can provide a relatively good solar reflectivity to a roofing product bearing them, additional improvements are necessary. The present inventors have determined certain aspects of shape, size and orientation that can provide additional advantages. For example, the present inventors have noted that the use of relatively flat solar-reflective roofing granules can provide additional solar reflectivity to the overall roofing product, especially when they are oriented such that they are substantially in the plane of the roofing product. In that regard, the present inventors have developed new ways for providing the desired orientation of relatively flat granules on a roofing product.

The present inventors have also noted that the size of the roofing granules can be important, with granules in certain size ranges providing improved reflectivity to the overall roofing product.

The present inventors have also determined new methods for making relatively flat solar-reflective roofing granules, using methods such as roll compaction to provide the desired shape to the granules.

Accordingly, one aspect of the disclosure is a collection of solar-reflective roofing granules having a solar reflectivity of at least 70%. At least 70 wt % (e.g., at least 80 wt % or even at least 90 wt %) of the solar-reflective roofing granules of the collection have a major aspect ratio of at least 4 and a minor aspect ratio of at least 3.

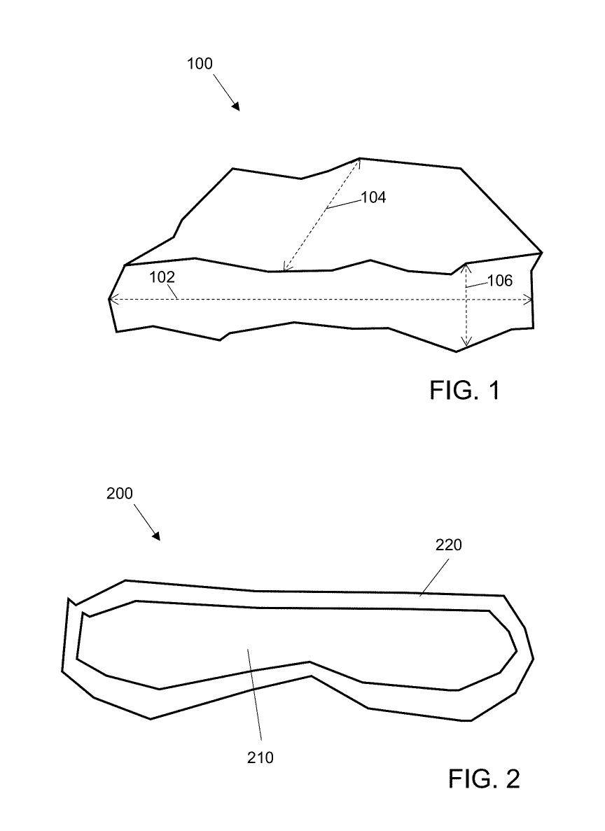

A schematic view of a roofing granule is shown in FIG. 1. Roofing granule 100 has a major axis 102, extending along the average plane of the roofing granule along its longest dimension. In the case of the particular roofing granule shown in FIG. 1, the longest dimension is along a side of the roofing granule; in other granules, the longest dimension may be along a diagonal. Roofing granule 100 also has minor axis 104, extending along the average plane of the roofing granule and perpendicular to the major axis 102. The minor axis extends along the longest dimension of the granule in the direction perpendicular to the major axis. Roofing granule 100 also has a thickness 106, in a direction perpendicular to the plane of major axis 102 and minor axis 104, taken as the maximum thickness in that direction. The major aspect ratio is defined as the ratio of the major axis to the thickness, while the minor aspect ratio is defined as the ratio of the minor axis to the thickness.

In certain embodiments as otherwise described herein, at least 70 wt % (e.g., at least 80 wt % or even at least 90 wt %) of the solar-reflective roofing granules of the collection have a major aspect ratio of at least 6. For example, in certain embodiments, at least 70 wt % (e.g., at least 80 wt % or even at least 90 wt %) of the solar-reflective roofing granules of the collection have a major aspect ratio of at least 8.

In certain embodiments as otherwise described herein, at least 70 wt % (e.g., at least 80 wt % or even at least 90 wt %) of the solar-reflective roofing granules of the collection have a minor aspect ratio of at least 5. For example, in certain embodiments, at least 70 wt % (e.g., at least 80 wt % or even at least 90 wt %) of the solar-reflective roofing granules of the collection have a major aspect ratio of at least 7.

The present inventors have noted that a flake-like geometry, especially in combination with certain granule size ranges, can provide for increased solar reflectivity and resistance to staining. Accordingly, in certain embodiments as otherwise described herein, in at least 70 wt % (e.g., at least 80 wt % or even at least 90 wt %) of the solar-reflective roofing granules of the collection the ratio of the major axis to the minor axis is in the range of 1-2. In certain such embodiments, in at least 70 wt % (e.g., at least 80 wt % or even at least 90 wt %) of the solar-reflective roofing granules of the collection the ratio of the major axis to the minor axis is in the range of 1-1.5, or 1-1.33.

The person of ordinary skill in the art will appreciate that the solar-reflective roofing granules can be provided in a wide variety of sizes. For example, in certain embodiments as otherwise described herein, at least 90 wt % of the solar-reflective roofing granules of the collection have a particle size in the range of ¼″ US mesh to #50 US mesh, e.g., #5 US mesh to #50 US mesh.

But the present inventors have determined that relatively larger granules can provide improvements not only in initial solar reflectivity, but also in resistance to degradation of solar reflectivity with time. Accordingly, in certain embodiments as otherwise described herein, least 50 wt % of the solar-reflective roofing granules have a particle size in the range of ¼″ US mesh to #30 US mesh, for example, ¼″ US mesh to #25 US mesh, #5 US mesh to 30 US mesh, or #5 US mesh to #25 US mesh. In certain embodiments, at least 70 wt % (e.g., at least 80 wt % or at least 90 wt %) of the solar-reflective roofing granules (have a particle size in the range of ¼″ US mesh to #30 US mesh, for example, ¼″ US mesh to #25 US mesh, #5 US mesh to 30 US mesh, or #5 US mesh to #25 US mesh. In certain embodiments, at least 50 wt % of the solar-reflective roofing granules have a particle size in the range of ¼″ US mesh to #20 US mesh, for example, #5 US mesh to 20 US mesh, ¼″ US mesh to 15 US mesh, #5 US mesh to #15 US mesh, or #12 US mesh to #20 US mesh, or #16 US mesh or #20 US mesh. For example, in certain embodiments, at least 70 wt % (e.g., at least 80 wt % or at least 90 wt %) of the solar-reflective roofing granules have a particle size in the range of ¼″ US mesh to #20 US mesh, for example, #5 US mesh to 20 US mesh, ¼″ US mesh to 15 US mesh, #5 US mesh to #15 US mesh, or #12 US mesh to #20 US mesh, or #16 US mesh or #20 US mesh.

However, it can be desirable to include some smaller particles in the granules that are applied to a roofing substrate, to help fill gaps between larger particles. For example, in certain embodiments, at least 10% by weight (e.g., at least 15 wt %, at least 20 wt % or even at least 30 wt %) of the granules of a collection of roofing granules as otherwise described herein have a particle size in excess of #20 mesh. And in certain such embodiments, at least 10% by weight (e.g., at least 15 wt %, at least 20 wt % or even at least 30 wt %) of the granules of the collection have a particle size in excess of #30 mesh. Such gap-filling granules need not have a high aspect ratio as described herein. Collections of granules that include both high-aspect ratio granules and lower aspect ratio granules can be the natural result of a particular granule manufacturing process, or instead can be made by combining a collection of high-aspect ratio granules as otherwise described herein with small low-aspect ratio granules, e.g., either before application to a roofing product or by application of two different types of granules to a roofing product in two process operations).

As used herein, the term “granule” does not apply to particles having a major dimension smaller than 0.2 mm.

The mineral roofing granules as described herein can advantageously have very high solar reflectivity values. As described above, the collection of solar-reflective roofing granules of the collection has a solar reflectivity of at least 70%. In certain such embodiments, a collection of mineral roofing granules as otherwise described herein has a solar reflectivity of at least 75%, at least 80%, or even at least 85%. Solar reflectivity of granules is measured of the granules as disposed on a flat surface (e.g., in a petri dish) packed in a thickness sufficient such that only granules are visible from above, using a solar reflectometer pursuant to ASTM C1549.

The solar-reflective roofing granules can have a variety of structures. For example, in certain embodiments as otherwise described herein, the solar-reflective roofing granules of the collection substantially comprise a base particle having a solar-reflective coating disposed thereon. By “substantially comprise” it is meant that nearly all of the solar-roofing granules of the collection have this structure, but that there may be a small proportion (e.g., less than 1%) that do not (e.g., by being incompletely coated).

Examples of the suitable base particles include crushed slate, slate granules, shale granules, granule chips, mica granules and metal flakes with a flake-like geometry.

In other embodiments, the base particle is a synthetic particle. As described in more detail below, the present inventors have determined that base particles having a desired geometry can be made by a variety of methods from, for example, clays and other preceramic materials.

Preferably, the solar-reflective coating applied to the base particles does not significantly affect the geometry of the resulting roofing granules. Thus, the coated roofing granules can have essentially the same geometry as the flat base particles from which they are formed (e.g., with respect to the aspect ratios and sizes as described above). The solar reflective coating can, however, smooth out the surface of the granule to reduce light trapping by reflection in defects.

In certain embodiments, the solar-reflective coating is white in color.

In certain desirable embodiments, in at least 90 wt % of the solar-reflective roofing granules of the collection, the surface area of the base particles is at least 80 percent covered with the solar-reflective coating, e.g., at least 85 percent, at least 90 percent or even at least 95 percent covered with the solar-reflective coating, and still more preferably the at least 98 percent covered with the solar-reflective coating. Still more preferably, in at least 90 wt % of the solar-reflective roofing granules of the collection, the base particles are encapsulated completely with the solar heat reflective coating; that is, the entire surface area of the base particles is covered with the solar heat reflective coating.

The composition and the thickness of the solar-reflective coating can selected to provide solar heat reflective roofing granules with a solar reflectivity of at least 70%, or any other desired value. For example, in certain embodiments, the thickness of the solar-reflective coating is at least one mil (0.001 inch, 2.54×10⁻⁵ m), more preferably at least 2 mils, and still more preferably at least 3 mils. The desired thickness of the solar-reflective coating will depend upon the concentration of solar-reflective pigment(s) in the coating and the nature of the solar-reflective pigment(s) in the coating. Preferably, the coating is uniform, such that the thickness of the coating does not vary by more than about 25 percent, more preferably by no more than about 10 percent, from the average coating thickness, at the 95 percent confidence interval. But different coatings can be formed in different thicknesses to provide a desired degree of reflectivity.

As the person of ordinary skill will appreciate, a variety of materials can be used as solar-reflective pigments in the coatings described herein. Examples of clays that can be used include kaolin, other aluminosilicate clays, Dover clay, bentonite clay, etc. Titanium dioxides such as rutile titanium dioxide and anatase titanium dioxide, metal pigments, titanates, and mirrorized silica pigments can also be used. Other solar-reflective pigments that can be adapted for use include calcium carbonate, zinc oxide, lithopone, zinc sulfide, white lead, and organic and inorganic opacifiers such as glass spheres.

Examples of mirrorized silica pigments that can be used in the solar-reflective roofing granules described herein include pigments such as Chrom Brite™ CB4500, available from Bead Brite, 400 Oser Ave, Suite 600, Hauppauge, N.Y. 11788.

An example of a rutile titanium dioxide that can be employed in the solar-reflective roofing granules described herein includes R-101, available from Du Pont de Nemours, P.O. Box 8070, Wilmington, Del. 19880.

Examples of metal pigments that can be employed in the solar-reflective roofing granules described herein include aluminum flake pigment, copper flake pigments, copper alloy flake pigments, and the like. Metal pigments are available, for example, from ECKART America Corporation, Painesville, Ohio 44077. Suitable aluminum flake pigments include water-dispersible lamellar aluminum powders such as Eckart RO-100, RO-200, RO-300, RO-400, RO-500 and RO-600, non-leafing silica coated aluminum flake powders such as Eckart STANDART PCR 212, PCR 214, PCR 501, PCR 801, and PCR 901, and STANDART Resist 211, STANDART Resist 212, STANDART Resist 214, STANDART Resist 501 and STANDART Resist 80; silica-coated oxidation-resistant gold bronze pigments based on copper or copper-zinc alloys such as Eckart DOROLAN 08/0 Pale Gold, DOROLAN 08/0 Rich Gold and DOROLAN 10/0 Copper.

Examples of titanates that can be employed in the solar-reflective roofing granules described herein include titanate pigments such as colored rutile, priderite, and pseudobrookite structured pigments, including titanate pigments comprising a solid solution of a dopant phase in a rutile lattice such as nickel titanium yellow, chromium titanium buff, and manganese titanium brown pigments, priderite pigments such as barium nickel titanium pigment; and pseudobrookite pigments such as iron titanium brown, and iron aluminum brown. The preparation and properties of titanate pigments are discussed in Hugh M. Smith, High Performance Pigments, Wiley-VCH, pp. 53-74 (2002).

Examples of near IR-reflective pigments available from the Shepherd Color Company, Cincinnati, Ohio, include Arctic Black 10C909 (chromium green-black), Black 411 (chromium iron oxide), Brown 12 (zinc iron chromite), Brown 8 (iron titanium brown spinel), and Yellow 193 (chrome antimony titanium).

Aluminum oxide, preferably in powdered form, can be used as a solar-reflective additive in a color coating formulation to improve the solar reflectivity of colored roofing granules without affecting the color. The aluminum oxide should have particle size less than #40 mesh (425 micrometers), preferably between 0.1 micrometers and 5 micrometers. More preferably, the particle size is between 0.3 micrometers and 2 micrometers. The alumina should have a percentage of aluminum oxide greater than 90 percent, more preferably greater than 95 percent. Preferably the alumina is incorporated into the granule so that it is concentrated near and/or at the outer surface of the granule.

A colored, infrared-reflective pigment can also be employed in preparing the solar-reflective roofing granules described herein. Preferably, the colored, infrared-reflective pigment comprises a solid solution including iron oxide, such as disclosed in U.S. Pat. No. 6,174,360, incorporated herein by reference. The colored infrared-reflective pigment can also comprise a near infrared-reflecting composite pigment such as disclosed in U.S. Pat. No. 6,521,038, incorporated herein by reference. Composite pigments are composed of a near-infrared non-absorbing colorant of a chromatic or black color and a white pigment coated with the near-infrared non-absorbing colorant. Near-infrared non-absorbing colorants that can be used include organic pigments such as organic pigments including azo, anthraquinone, phthalocyanine, perinone/perylene, indigo/thioindigo, dioxazine, quinacridone, isoindolinone, isoindoline, diketopyrrolopyrrole, azomethine, and azomethine-azo functional groups. Preferred black organic pigments include organic pigments having azo, azomethine, and perylene functional groups. When organic colorants are employed, a low temperature cure process is preferred to avoid thermal degradation of the organic colorants.

While in some embodiments the coatings are colored, in order to achieve high solar reflectivity, in one presently preferred embodiment, the binder, pigment, and ratio of pigment to binder are selected such that the solar-reflective granules are white in color. In certain embodiments, the collection of solar-reflective granules has (a*²+b*²)^{1/2} less than 10, e.g., less than 6, or even less than 2.5. In certain embodiments the collection of solar-reflective granules have an L* of at least 75, more preferably at least 80, still more preferably at least 85, and even more preferably at least 90. L*, a* and b* can be determined in the configuration described above with respect to solar reflectivity of granules.

Coating materials useful in the granules described herein can include a coating binder and one or more pigments, for example, together with functional fillers and/or functional additives for improved processing, to improve dispersion of pigments, to space out pigments for optimal scattering, to enhance fire resistance, to provide algae resistance, etc.

Preferably, the coating material, including the coating binder, the pigments employed, and the additives, applied to the base particles is suitable for roofing applications. Coating materials which provide coatings with very good outdoor durability are preferred. It is also preferred that the coating material employed provide a coating with excellent fire resistance.

Examples of coating binders that can be used in the granules described herein include metal silicates, fluoropolymers, metal phosphates, silica coatings, sol-gel coatings, polysiloxanes, silicone coating, polyurethane coating, polyacrylates, or their combinations.

Coating compositions employed in the granules described herein can include inorganic binders such as ceramic binders, and binders formed from silicates, silica, zirconates, titanates, phosphate compounds, et al. For example, the coating composition can include sodium silicate and/or kaolin clay.

Organic binders can also be employed in the granules described herein. The use of suitable organic binders, when cured can also provide superior granule surface with enhanced granule adhesion to the asphalt substrate and with better staining resistance to asphaltic materials. Roofing granules including inorganic binders often require additional surface treatments to impart certain water repellency for granule adhesion and staining resistance. U.S. Pat. No. 5,240,760 discloses examples of polysiloxane-treated roofing granules that provide enhanced water repellency and staining resistance. With the organic binders, the additional surface treatments may be eliminated. Also, certain organic binders, particularly those water-based systems, can be cured by drying at much lower temperatures as compared to the inorganic binders such as metal-silicates, which often require curing at temperatures greater than about 500 degrees C. or by using a separate process to render the coating durable.

Examples of organic binders that can be employed in the granules described herein include acrylic polymers, alkyds and polyesters, amino resins, melamine resins, epoxy resins, phenolics, polyamides, polyurethanes, silicone resins, vinyl resins, polyols, cycloaliphatic epoxides, polysulfides, phenoxy, fluoropolymer resins. Examples of uv-curable organic binders that can be employed in the granules described herein include uv-curable acrylates, uv-curable polyurethanes, uv-curable cycloaliphatic epoxides, and blends of these polymers. In addition, electron beam-curable polyurethanes, acrylates and other polymers can also be used as binders. High solids, film-forming, synthetic polymer latex binders are useful in the granules described herein. Presently preferred polymeric materials useful as binders include uv-resistant polymeric materials, such as poly(meth)acrylate materials, including poly methyl methacrylate, copolymers of methyl methacrylate and alkyl acrylates such as ethyl acrylate and butyl acrylate, and copolymers of acrylate and methacrylate monomers with other monomers, such as styrene. Preferably, the monomer composition of the copolymer is selected to provide a hard, durable coating. If desired, the monomer mixture can include functional monomers to provide desirable properties, such as crosslinkability to the copolymers. The organic material can be dispersed or dissolved in a suitable solvent, such as coatings solvents well known in the coatings arts, and the resulting solution used to coat the granules. Alternatively, water-borne emulsified organic materials, such as acrylate emulsion polymers, can be employed to coat the granules, and the water subsequently removed to allow the emulsified organic materials of the coating composition to coalesce. When a fluidized bed coating device is used to coat the inorganic particles, the coating composition can be a 100 percent solids, hot-melt composition including a synthetic organic polymer that is heated to melt the composition before spray application.

The coating material can further include one or more functional additives. Examples of such functional additives include curing agents for the binder, pigment spacers, such as purified kaolin clays, and viscosity modifiers. The coating material can also contain biocides or algaecides for obtaining resistance to microbial discoloration.

The solar-reflective coating can be applied to the base particles by any coating process known in the art. However, coating processes which provide a uniform coating on the base particles are preferred. Preferably, the coating weight per unit surface area varies by no more than ten percent, more preferably by no more than five percent, and still more preferably, by no more than two percent. Preferably, the coating completely covers the base particles. Further, it is preferred that there be no areas of the base particles which are covered with only a nominal thickness of coating or which are not coated at all.

Examples of coating process which can be employed in preparing the roofing granules described herein include fluidized bed coating, encapsulation by gelation, chelation, solvent evaporation, coacervation, vesicle formation, and spinning disk encapsulation. In certain embodiments of the methods of the disclosure, fluidized bed coating is preferred. Suitable coating methods are disclosed in commonly assigned U.S. Patent Application Publication 2006/0251807 A1, incorporated herein by reference. This type of coating device is preferably employed to provide a precise and uniform coating on the surface of the particles. Multiple coating layers can be applied in a single batch by applying a sequence of coating materials to the particles through a suitable spray nozzle. Wurster-type fluidized bed spray devices are available from a number of vendors, including Glatt Air Techniques, Inc., Ramsey, N.J. 07446; Chungjin Tech. Co. Ltd., South Korea; Fluid Air Inc., Aurora, Ill. 60504, and Niro Inc., Columbia, Md. 21045. The nature, extent, and thickness of the coating provided in a Wurster-type fluidized bed spray device depends upon a number of parameters including the residence time of the particles in the device, the particle shape, the particle size distribution, the temperature of the suspending airflow, the temperature of the fluidized bed of particles, the pressure of the suspending airflow, the pressure of the atomizing gas, the composition of the coating material, the size of the droplets of coating material, the size of the droplets of coating material relative to the size of the particles to be coated, the spreadability of the droplets of coating material on the surface of the particles to be coated, the loading of the device with the mineral particles or batch size, the viscosity of the coating material, the physical dimensions of the device, and the spray rate. Modified Wurster-type devices and processes, such as, the Wurster-type coating device disclosed in U.S. Patent Publication 2005/0069707, incorporated herein by reference, for improving the coating of asymmetric particles, can also be employed. In addition, lining the interior surface of the coating device with abrasion-resistant materials can be employed to extend the service life of the coater.

Other types of batch process particle fluidized bed spray coating techniques and devices can be used. For example, the particles can be suspended in a fluidized bed, and the coating material can be applied tangentially to the flow of the fluidized bed, as by use of a rotary device to impart motion to the coating material droplets.

In the alternative, other types of particle fluidized bed spray coating can be employed. For example, the particles can be suspended as a fluidized bed, and coated by spray application of a coating material from above the fluidized bed. In another alternative, the particles can be suspended in a fluidized bed, and coated by spray application of a coating material from below the fluidized bed, such as is described in detail above. In either case, the coating material can be applied in either a batch process or a continuous process. In coating devices used in continuous processes, uncoated particles enter the fluidized bed and can travel through several zones, such as a preheating zone, a spray application zone, and a drying zone, before the coated particles exit the device. Further, the particles can travel through multiple zones in which different coating layers are applied as the particles travel through the corresponding coating zones.

In the spinning disc method the granules and droplets of the liquid coating material are simultaneously released from the edge of a spinning disk, such as disclosed, for example, in U.S. Pat. No. 4,675,140.

Other processes suitable for depositing uniform coating on the granules will become apparent to those who are skilled in the art.

For example, magnetically assisted impaction coating (“MAIC”) available from Aveka Corp., Woodbury, Minn., can be used to coat granules with solid particles such as titanium dioxide. Other techniques for coating dry particles with dry materials can also be adapted for use in the present process, such as the use of a Mechanofusion device, available from Hosokawa Micron Corp., Osaka, JP; a Theta Composer device, available from Tokuj Corp., Hiratsuka, JP, and a Hybridizer device, available from Nara Machinery, Tokyo, JP.

Depending on the nature of the binder used to prepare the coating material, after application of the coating material to the base particles to form a coating layer, it may be necessary to cure the binder, as by application of heat, by application of ultraviolet radiation, or the like. If the binder is dispersed in a solvent such as water or an organic solvent, it may be necessary to drive off the solvent from the coating material after application of the coating material to the base particles to form a coating layer in order to encourage film formation, or otherwise “cure” the coating material. If the binder is a high solids material, cure may be effected by simply permitting the coated particles to cool after application of the coating material to the base particles to form a coating layer at an elevated temperature.

As described above, in certain embodiments of the disclosure, the base particle is a synthetic particle. As described in more detail below, the present inventors have determined that base particles having a desired geometry can be made by a variety of methods from, for example, clays and other preceramic materials. Examples of such materials include those described, for example, in U.S. Pat. No. 7,811,730, U.S. Patent Applications Publications nos. 20100151199 and 20100203336, and U.S. Provisional Patent Application No. 62/610,991, each of which is hereby incorporated herein by reference in its entirety. For example, the base particles can be formed by forming a preceramic material in desired shapes, then firing that formed material to provide base particles. The preceramic material can be, for example, a mixture of particulate material with a suitable binder, such as the binders otherwise described herein. A wide variety of particulate materials can be used, e.g., stone dust, granule fines, can be used. In other embodiments, a clay such as bauxite or kaolin can be used as the preceramic material. Extrusion, casting or like process can in some embodiments be used to provide base particles having the sizes and aspect ratios. Examples of processes for providing base particles having a predetermined desired shape are given by U.S. Pat. No. 7,811,630 incorporated herein by reference.

Additional methods for providing base particles of a desired shape are described in more detail below.

In other embodiments, the solar-reflective roofing granules of the collection are substantially formed from a single composition. [That is, instead of coating a base particle with a solar-reflective coating, substantially the entire granule can be formed from solar-reflective material. Such granules can include thin coatings on their outsides, e.g., formed of an organic or silicone-based coating, but can otherwise be formed from a single composition. Even though the materials are formed from a single composition, there can be some differences in distribution of materials or other properties within a single granule, e.g., with certain components or properties being more evident at a surface as compared to the bulk of the granule material.

The present inventors have determined that aluminosilicate clay-containing compositions can be especially useful for making particles and coatings as described herein. For example, in many embodiments, the preceramic composition from which a particle or coating is formed herein generally includes an aluminosilicate clay, in certain embodiments, in combination with one or more additives selected from a zinc source, a feldspar, nepheline syenite and sodium silicate. Firing (i.e., heating of a material to an elevated temperature) of the mixtures described herein can cause both calcination and densification to result in a fired material that is different in density and/or composition from the preceramic mixture. In typical embodiments, some degree of both calcination and densification (e.g., through sintering) occurs during the firing process.

Notably, in certain embodiments of the granules as otherwise described herein, the mineral outer surface of the mineral roofing granules has a surface porosity of no more than about 10% as measured by mercury porosimetry. For example, in certain embodiments of the mineral roofing granules as otherwise described herein, the mineral outer surface of the mineral roofing granules has a surface porosity of no more than about 5% as measured by mercury porosimetry. In other embodiments of the mineral outer surface of the mineral roofing granules has a surface porosity of no more than about 3% as measured by mercury porosimetry. In other embodiments of the mineral outer surface of the mineral roofing granules has a surface porosity of no more than about 2% as measured by mercury porosimetry. In other embodiments of the mineral outer surface of the mineral roofing granules has a surface porosity of no more than about 1% as measured by mercury porosimetry. As described above, the present inventors have determined that a low surface porosity can provide for increased resistance to long-term staining, e.g., a reduced “drop” in solar reflectivity when applied to a heated bituminous roofing substrate. The person of ordinary skill in the art will, based on the description herein, select fireable mixtures, granulation methods and firing conditions that provide a desirably low porosity. Such low porosities can be provided, for example, when the aluminosilicate-clay containing materials described here are used as a coating or as the granule body.

In certain embodiments of the roofing granules as otherwise described herein, the fired material is a fired mixture comprising an aluminosilicate clay. As used herein, a “fired mixture” is defined by the components of the mixture that is fired to form a “fired material.” The fired mixture is defined on dry basis, i.e., exclusive of any water or solvent that is used to provide the fired mixture with formability. Aluminosilicate clays can be used to make highly solar-reflective mineral roofing granules.

In certain embodiments of the mineral roofing granules as otherwise described herein, the fired mixture further includes a feldspar, nepheline syenite, and/or a sodium silicate. Materials such as feldspars, nepheline syenite and sodium silicates can increase the flowability of a clay material by lowering of the melting point of the material and thus promoting liquefaction at a given firing temperature, and as such can allow for a decreased porosity.

In certain embodiments of the mineral roofing granules as otherwise described herein, the fired mixture further includes a zinc source. As the person of ordinary skill in the art will appreciate, the zinc source can be converted in the firing to zinc compounds such as zinc oxide, zinc silicates, zinc aluminosilicates and zinc aluminates. As described in further detail below, the use of a zinc source can not only provide algae resistance to the mineral roofing granule, but can also provide a decreased porosity at the mineral outer surface of the mineral roofing granule, especially when used in combination with a feldspar, a sodium silicate and/or a nepheline syenite. Zinc oxide can also provide white color and increased solar reflectivity, and as such can be helpful in providing the solar reflectivities described herein.

In certain embodiments of the roofing granules as otherwise described herein, the aluminosilicate clay of the fired mixture is a kaolin clay. As the person of ordinary skill in the art will appreciate, a “kaolin clay” or “kaolin” is a material comprising kaolinite, quartz and feldspar. For use in the mineral roofing granules as described herein, it is desirable that the kaolin have a kaolinite content of at least about 80 weight percent, for example, at least about 90 weight percent, or even at least about 95 weight percent. As used herein, the amount of any feldspar, nepheline syenite and sodium silicate present in the kaolin (or other aluminosilicate clay) of a mixture to be fired is calculated as part of the kaolin (or other aluminosilicate clay) component, and not part of the feldspar, nepheline syenite or sodium silicate component.

The person of ordinary skill in the art will appreciate that a variety of types or grades of kaolin can be used. The kaolin used in the mineral roofing granules described herein can be (or can include), for example, a kaolin crude material, including kaolin particles, oversize material, and ferruginous and/or titaniferous and/or other impurities, having particles ranging in size from submicron to greater than 20 micrometers in size. Alternatively, in certain desirable embodiments, a refined grade of kaolin clay can be employed, such as, for example, a grade of kaolin clay including mechanically delaminated kaolin particles. Further, grades of kaolin such as those coarse grades used to extend and fill paper pulp and those refined grades used to coat paper can be employed in the mineral roofing granules as described herein. Examples of kaolins suitable for use in the mineral roofing granules as described herein include, for example, EPK Kaolin (Edgar Materials), for example in jet-milled form; Kaobrite 90 (Thiele Kaolin); and SA-1 Kaolin (Active Minerals). Kaolins can be subjected to any of a number of conventional processes to beneficiate them, e.g., blunging, degritting, classifying, magnetically separating, flocculating, filtrating, redispersing, spray drying, pulverizing and firing.

In certain embodiments of the roofing granules as otherwise described herein, a different aluminosilicate clay can be used in combination with or instead of the kaolin. For example, in certain embodiments of the roofing granules as otherwise described herein, the aluminosilicate clay is (or includes) bauxite. In certain embodiments of the roofing granules as otherwise described herein, the aluminosilicate clay is (or includes) chamotte. In certain embodiments of the roofing granules as otherwise described herein, the aluminosilicate clay is (or includes) a white clay such as ball clay or montmorillonite. In certain embodiments of the roofing granules as otherwise described herein, the aluminosilicate clay is (or includes) a white clay such as ball clay or montmorillonite. However, in certain desirable embodiments, at least 50 wt %, e.g., at least 70 wt %, at least 80 wt %, at least 90 wt %, or even at least 95 wt % of the aluminosilicate clay is kaolin.

The person of ordinary skill in the art will, on the basis of the description provided herein, select aluminosilicate clay(s) that provide a high degree of whiteness, and thus a high degree of solar reflectivity. Two important impurities aluminosilicate clays such as kaolin are iron and titanium. Iron can create highly-colored impurities, especially upon firing and especially when present in combination with titanium. Accordingly, in certain desirable embodiments of the mineral roofing granules as otherwise described herein, the aluminosilicate clay of the fired mixture has no more than 1 wt % iron, e.g. no more than 0.7 wt % or no more than 0.5 wt % iron, as measured by inductively-coupled plasma mass spectrometry (ICP-MS) and reported as Fe₂O₃. Similarly, in certain desirable embodiments of the mineral roofing granules as otherwise described herein, the aluminosilicate clay of the fired mixture has no more than 1 wt % titanium, e.g., no more than 0.7 wt % no more than 0.5 wt % titanium, measured by ICP-MS and reported as TiO₂. The person of ordinary skill in the art can select suitable clays having low amounts of iron and titanium.

In certain embodiments of the mineral roofing granules as otherwise described herein, the aluminosilicate clay is present in the fired mixture in an amount in the range of 40-90 wt % (i.e., exclusive of water or any solvent used to moisten the mixture for formability). For example, in various embodiments of the mineral roofing granules as otherwise described herein, the aluminosilicate clay is present in the fired mixture in an amount in the range of 40-80 wt %, or 40-70 wt %, or 40-60 wt %, or 50-90 wt %, or 50-80 wt %, or 50-70 wt %, or 60-90 wt %, or 60-80 wt %, or 70-90 wt %. The person of ordinary skill in the art will, based on the disclosure herein, select an amount of aluminosilicate clay, e.g., in combination with other components, that provides the desired solar reflectivity and stain resistance to the mineral roofing granules.

In certain embodiments of the mineral roofing granules as otherwise described herein, the fired mixture includes a feldspar. As noted above, the feldspar of the fired mixture is a component separate from any kaolin or other aluminosilicate clay present, and thus the feldspar component is not said to include any feldspar present in the kaolin or other aluminosilicate clay. As noted above, the use of feldspar can lower the effective sintering temperature of the overall fired mixture, and as such can provide for a lower degree of surface porosity at a given firing temperature. As the person of ordinary skill in the art will appreciate, feldspars are aluminosilicates of sodium, potassium, calcium and/or barium. Most commonly, the feldspars are considered as solid solutions of three limiting compounds, soda feldspar, potash feldspar and lime feldspar. Accordingly, in certain embodiments of the mineral roofing granules as otherwise described herein, the feldspar is one or more of a soda feldspar, a potash feldspar, and a lime feldspar. For example, in certain embodiments of the mineral roofing granules as otherwise described herein, the feldspar is (or includes) a soda feldspar. In certain embodiments of the mineral roofing granules as otherwise described herein, the feldspar is (or includes) a potash feldspar. In certain embodiments of the mineral roofing granules as otherwise described herein, the feldspar is (or includes) a lime feldspar. MINSPAR™ 4 (Imerys) is an example of a suitable feldspar for use in the mineral roofing granules described herein. The person of ordinary skill in the art will appreciate that other feldspars, such as plagioclase (solid solution between albite and anorthite), alkali feldspars (solid solutions between K-feldspar and albite) and barium feldspars can be suitable for use in the preparation of the mineral granules as otherwise described herein.

The person of ordinary skill in the art will, based on the disclosure herein, select an amount of a feldspar, in combination with the other component(s), that provides the desired solar reflectivity and stain resistance to the mineral roofing granules. For example, in certain embodiments of the mineral roofing granules as otherwise described herein, the feldspar is present in the fired mixture in an amount in the range of 2-40 wt % (i.e., exclusive of water or any solvent used to moisten the mixture for formability). In various embodiments of the mineral roofing granules as otherwise described herein, the feldspar is present in the fired mixture in an amount in the range of 2-30 wt %, or 2-25 wt %, or 2-20 wt %, or 2-15 wt %, or 2-15 wt %, or 5-40 wt %, or 5-30 wt %, or 5-25 wt %, or 5-20 wt %, or 5-15 wt %, or 10-40 wt %, or 10-30 wt %, or 10-25 wt %, or 10-20 wt %, or 15-40 wt %, or 15-30 wt %, or 15-25 wt %, or 20-40 wt %, or 20-35 wt %, or 20-30 wt %.

However, in other embodiments of the mineral roofing granules as otherwise described herein, the fired mixture does not include a substantial amount of feldspar (i.e., separate from any feldspar in nepheline syenite that is present). For example, in certain embodiments, the fired mixture includes less than 1 wt %, less than 0.5 wt %, or even less than 0.2 wt % feldspar.

In certain embodiments of the mineral roofing granules as otherwise described herein, the fired mixture includes a sodium silicate (e.g., in combination with, or instead of the feldspar). Like the feldspar, the sodium silicate of the fired mixture is a component separate from any kaolin or other aluminosilicate clay present, and thus the sodium silicate component is not said to include any sodium silicate present in the kaolin or other aluminosilicate clay. As noted above, the use of sodium silicate can lower the effective sintering temperature of the overall fired mixture, and as such can provide for a lower degree of surface porosity at a given firing temperature.

The person of ordinary skill in the art will, based on the disclosure herein, select an amount of a sodium silicate, in combination with the other component(s), that provides the desired solar reflectivity, stain resistance and low crystalline silica content to the mineral roofing granules. For example, in certain embodiments of the mineral roofing granules as otherwise described herein, the sodium silicate is present in the fired mixture in an amount in the range of 5-40 wt % (i.e., exclusive of water or any solvent used to moisten the mixture for formability). In various embodiments of the mineral roofing granules as otherwise described herein, the sodium silicate is present in the fired mixture in an amount in the range of 5-30 wt %, or 5-25 wt %, or 5-20 wt %, or 5-15 wt %, or 10-40 wt %, or 10-30 wt %, or 10-25 wt %, or 10-20 wt %, or 15-40 wt %, or 15-30 wt %, or 15-25 wt %, or 20-40 wt %, or 20-35 wt %, or 20-30 wt %. Of course, in other embodiments, substantially no separate sodium silicate component (i.e., separate from the feldspar and/or nepheline syenite) is present in the fired mixture. For example, in certain embodiments, the fired mixture includes less than 1 wt %, less than 0.5 wt %, or even less than 0.2 wt % sodium silicate.

The person of ordinary skill in the art will, based on the disclosure herein, select an amount of a nepheline syenite, in combination with the other component(s), that provides the desired solar reflectivity and low crystalline content to the mineral roofing granules. For example, in certain embodiments of the mineral roofing granules as otherwise described herein, the nepheline syenite is present in the fired mixture in an amount in the range of 2-40 wt % (i.e., exclusive of water or any solvent used to moisten the mixture for formability). In various embodiments of the mineral roofing granules as otherwise described herein, the nepheline syenite is present in the fired mixture in an amount in the range of 2-30 wt %, or 2-25 wt %, or 2-20 wt %, or 2-15 wt %, or 2-15 wt %, or 5-40 wt %, or 5-30 wt %, or 5-25 wt %, or 5-20 wt %, or 5-15 wt %, or 10-40 wt %, or 10-30 wt %, or 10-25 wt %, or 10-20 wt %, or 15-40 wt %, or 15-30 wt %, or 15-25 wt %, or 20-40 wt %, or 20-35 wt %, or 20-30 wt %. In certain embodiments, when the fired mixture includes the nepheline syenite, it does not include a substantial amount of feldspar. And in certain embodiments, when the fired mixture includes the nepheline syenite, it does not include a substantial amount of sodium silicate.

However, in other embodiments of the mineral roofing granules as otherwise described herein, the fired mixture does not include a substantial amount of nepheline syenite. For example, in certain embodiments, the fired mixture includes less than 1 wt %, less than 0.5 wt %, or even less than 0.2 wt % nepheline syenite.

In certain embodiments of the mineral roofing granules as otherwise described herein, the fired mixture includes a zinc source. As the person of ordinary skill in the art will appreciate, the zinc source can be substantially any zinc compound that, when fired together with an aluminosilicate source provides inorganic zinc, e.g., in the form of one or more of a zinc oxide, a zinc silicate, a zinc aluminosilicate and a zinc aluminate. For example, in certain embodiments of the mineral roofing granules as otherwise described herein, the zinc source is (or includes) zinc oxide. In certain embodiments of the mineral roofing granules as otherwise described herein, the zinc source is (or includes) one or more of zinc oxide, zinc sulfide, zinc sulfate, zinc borate, a zinc silicate, a zinc aluminate, or a zinc aluminosilicate. Advantageously, the inventors have surprisingly found that the use of a zinc source can surprisingly provide a lower porosity to a fired material at a given firing temperature, especially when used in combination with a feldspar, a nepheline syenite and/or a sodium silicate. The use of a zinc source can also provide a mineral roofing granule with algae resistance, and can also provide increased whiteness to the fired material overall.

The person of ordinary skill in the art will, based on the disclosure herein, select an amount of a zinc source, in combination with the other component(s), that provides the desired solar reflectivity and stain resistance to the mineral roofing granules. For example, in certain embodiments of the mineral roofing granules as otherwise described herein, the zinc source is present in the fired mixture in an amount in the range of 1-30 wt % (i.e., exclusive of water or any solvent used to moisten the mixture for formability). In various embodiments of the mineral roofing granules as otherwise described herein, the sodium silicate is present in the fired mixture in an amount in the range of 1-25 wt %, or 1-20 wt %, or 1-15 wt %, or 5-30 wt %, or 5-25 wt %, or 5-20 wt %, or 15-30 wt %, or 10-25 wt %, or 15-30 wt %. The zinc source can be provided in a variety of particle sizes. In certain embodiments, the particle size (median) of the zinc source (e.g., ZnO) can be in the range of 50-500 nm, e.g., 100-500 nm, 50-250 nm, or 100-200 nm.

The zinc source can in some cases be transformed during firing to one or more different zinc compounds. The person of ordinary skill in the art will appreciate that the zinc makeup of the fired material will depend on, e.g., the particular composition of the zinc source used, the firing conditions (e.g., time and temperature), and the particular composition(s) of the other component(s) of the fired mixture. In certain embodiments of the mineral roofing granules as otherwise described herein, at least 50% (e.g., at least 60%, at least 70%) of the zinc present in the fired material is present as a zinc oxide or a zinc silicate, as determined by X-ray crystallography. In other embodiments of the mineral roofing granules as otherwise described herein, at least 50% (e.g., at least 60%, at least 70%) of the zinc present in the fired material is present as a zinc oxide, a zinc aluminate, a zinc aluminosilicate or a zinc silicate, as determined by X-ray crystallography. And in certain desirable embodiments of the roofing granules as otherwise described herein, no more than 40% (e.g., no more than 30%, no more than 20%) of the zinc present in the fired material is present as ZnAl₂O₄, as determined by X-ray crystallography. ZnAl₂O₄ is much less leachable at acidic pH than other commonly-used forms of zinc (e.g., ZnO and Zn silicate). Through selection of components in the mixtures to be fired and of firing temperatures based on the disclosure herein, the person of ordinary skill in the art can provide a desired balance of ZnAl₂O₄ as compared to other zinc forms, and thereby provide a desired overall rate of leaching. As demonstrated by Y. Tang et al., Environmental Technology, 36: 23, 2977-2986 (2015), ZnAl₂O₄ tends to form at higher firing temperatures. Use of a feldspar, a nepheline syenite, or a sodium silicate together with a zinc source can be unexpectedly advantaged in that it can allow for firing at lower temperatures to provide a given level of porosity and solar reflectivity, and allow the person of ordinary skill in the art to provide material with a desirable relative amounts of ZnAl₂O₄ with respect to other zinc forms in an as-fired material. The person of ordinary skill in the art will, based on the description herein, select amounts of feldspar, nepheline syenite and/or sodium silicate, amounts of zinc source and firing conditions to provide the desired algae resistance in combination with a desired solar reflectivity, a desired level of crystalline silica, and a desired stain resistance.

In certain embodiments of the mineral roofing granules as otherwise described herein, the fired material is a fired aluminosilicate material including in the range of 1-30 wt % zinc, measured on a zinc oxide basis (i.e., assuming that all zinc is in the form of ZnO). In certain such embodiments, the zinc is present in the fired material in an amount in the range of 1-25 wt %, or 1-20 wt %, or 1-15 wt %, or 5-30 wt %, or 5-25 wt %, or 5-20 wt %, or 10-30 wt %, or 10-25 wt %, or 10-30 wt %. The person of ordinary skill in the art will appreciate that the fired material can include a number of different crystalline phases. However, in certain desirable embodiments, the fired material includes less than 10 wt %, less than 5 wt %, less than 2 wt %, or even less than 1 wt % cristobalite. The inventors have noted that the use of feldspar, nepheline syenite and/or sodium silicate as described herein can allow for relatively low firing temperatures, below the temperature at which significant amounts of crystalline silica phases (especially cristobalite and quartz) can form. And, critically, the inventors have determined that even at high firing temperatures, mixtures including nepheline syenite can provide very low amounts of crystalline silica. This can allow for relatively high firing temperatures to be used to provide a low surface porosity, without creating an undesirably high amount of crystalline silica.

The fired material has been described above with respect to its position at the mineral outer surface of a roofing granule. The fired material can be present, for example, through at least a depth of 50 microns of the mineral roofing granule. In certain embodiments, the fired material is present through at least a depth of 100 microns, or even 200 microns of the mineral roofing granule.

In certain embodiments of the mineral roofing granules as otherwise described herein, the composition of the mineral body of the mineral roofing granule is substantially homogeneous throughout. That is, the mineral body, extending substantially to the mineral outer surface, has a substantially homogeneous composition. This does not, however, mean that there is no phase or material separation within the mineral body. Rather, “substantially homogeneous” is used here to signify that there is no large-scale region (e.g., having a diameter of 200 microns) of the mineral body that is different in overall composition from another large-scale region (e.g., having a diameter of 200 microns) of the mineral body.

In certain embodiments of the mineral roofing granules as otherwise described herein, the porosity of the mineral body is substantially homogeneous throughout. That is, the mineral body, extending substantially to the mineral outer surface, has a substantially homogeneous porosity.

However, in other embodiments of the mineral roofing granules as otherwise described herein, the porosity of the mineral body is substantially higher than the porosity at the mineral outer surface. For example, without intending to be bound by theory, the inventors surmise that in some cases the feldspar, nepheline syenite and/or sodium silicate can migrate to the particle surface, providing a higher degree of densification and therefore a lower porosity than in the rest of the mineral roofing granule even in a mineral roofing granule made from a single fired mixture. And in some embodiments, multiple fired mixtures can be used to make the mineral roofing granules, with a higher amount of one or more of the zinc source, feldspar, nepheline syenite and/or sodium silicate in the mixture used at the mineral outer surface of the mineral roofing granule. This, too, can lead to increased densification and therefore lower porosity at the surface. A higher degree of porosity in the mineral body can help to improve solar reflectivity of the mineral roofing granule.

Granules and base particles made from the preceramic mixtures described herein can be made by forming a green granule or particle (e.g., as generally described above, and described in more detail below), then firing the green granule or particle to provide the granule or particle. The firing converts the mixture to the fired composition.

The first mixture can have the mineral components as described above (e.g., as identified and in the same amounts) with respect to the first fired mixture. Moreover, as the person of ordinary skill in the art will appreciate, the first mixture can further include one or more solvents (e.g., water, an organic solvent such as a lower alcohol). As noted above, the amount of the solvent is not used in the calculation of the amounts of the components of a such a mixture to be fired. The first mixture can also further include an organic binder. As the person of ordinary skill in the art will appreciate, a binder can improve pelletizing and other forming processes, and can help to increase the strength of the green granules. Suitable binders include, for example, a starch, a resin, a wax, a glue such as AR animal glue, gelatinized cornstarch, calcium carbonate and polyvinyl alcohol. Such a binder can be used in amounts, for example, up to 6 wt % of the first mixture, e.g., up to 3% or up to 2%.

Again, the aluminosilicate clay-containing materials described here can be used not only as a material for a roofing granule, but also in the alternative as a coating for a base particle (e.g., made of slate). Such uses are described in U.S. Provisional Patent Application No. 62/610,991, which is hereby incorporated herein by reference in its entirety.

FIG. 2 is a cross-sectional schematic view of a coated solar-reflective roofing granule of the disclosure. Granule 200 has a base particle 210, coated by solar-reflective coating 220.

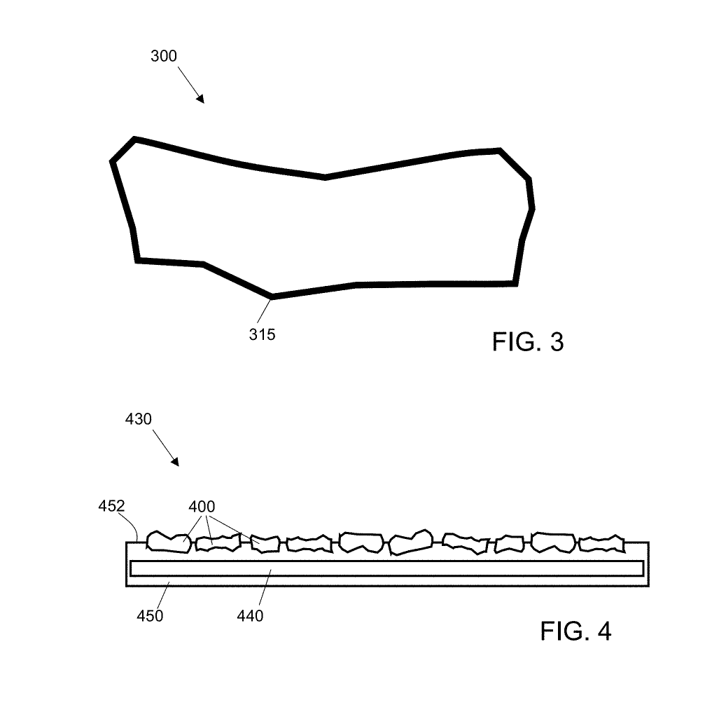

FIG. 3 is a cross-sectional schematic view of another solar-reflective roofing granule of the disclosure. Granule 300 is formed substantially from a single composition, e.g., from an aluminosilicate clay-containing fireable mixture. The granule presents a solar reflective surface due to the granule being substantially formed from a solar reflective material. Such granules can, of course, have thin coatings formed thereon, as long as such a coating does not make the overall granule non-reflective. For example, such a coating can be derived from a material selected from silanes, siloxanes, polysiloxanes, organo-siloxanes, silicates, organic silicates, silicone resins, acrylics, urethanes, polyurethanes, glycol ethers and mixtures thereof. Examples of coatings and methods for coating are described in U.S. Pat. App. Publication no. 20110081537, U.S. Pat. Nos. 7,241,500, 3,479,201, 3,255,031, and 3,208,571, all of which are incorporated herein by reference in their entirety for all purposes. In certain desirable embodiments, the coating has a transmittance to visible radiation of at least 80%, at least 90%, or even at least 95%. In the embodiment of FIG. 3, granule 300 includes a thin coating 315 at its outer surface.

Another aspect of the disclosure is a roofing product comprising a substrate; a bituminous material coated on the substrate, the bituminous material having a top surface; and a collection of solar-reflective roofing granules as described herein disposed on the top surface of the bituminous material, thereby substantially coating the bituminous material. The roofing products of the disclosure can be configured, e.g., in the form of a roofing shingle, or in the form of a roofing membrane.

One embodiment of such a roofing product is shown in schematic cross-sectional view in FIG. 4. In the embodiment of FIG. 4, roofing product 430 includes substrate 440, having a bituminous material 450 disposed thereon. Bituminous material 450 has top surface 452. As the person of ordinary skill in the art will appreciate, the bituminous material can be coated on both surfaces of, or even saturate the roofing substrate. A variety of materials can be used as the substrate, for example, conventional bituminous shingle or membrane substrates such as roofing felt or fiberglass. A collection of solar-reflective roofing granules 400 is disposed on the top surface 452 of the bituminous material 450, such that they substantially coat the bituminous material in a region 455 thereof. The region can be, for example, the exposure zone of a shingle, or a region that is otherwise to be exposed when the roofing product is installed on a roof. The solar-reflective roofing granules are desirably embedded somewhat in the bituminous material to provide for a high degree of adhesion. As the person of ordinary skill in the art will appreciate, other granular or particulate material can coat the bituminous material in regions that will not be exposed, e.g., on a bottom surface of the roofing product, or in a headlap zone of a top surface of the roofing product, as is conventional.

Notably, the present inventors have determined that the orientation of the solar-reflective roofing granules can have an important impact on the solar reflectivity of the overall roofing product. In certain desirable embodiments as otherwise described herein, the roofing product has a major plane, wherein each roofing granule has a major axis, a minor axis perpendicular to the major axis, and a thickness, and wherein for at least 90% (counted numerically) of the roofing granules having a major aspect ratio of at least 4, the major axis and the minor axis are disposed within 20 degrees of parallel to the major plane of the roofing product. The present inventors have noted that the overall roughness of the surface of the roofing product has a significant effect on the solar reflectivity, and that orienting the granules to be close to parallel to the surface can help to provide a low apparent roughness. In certain such embodiments, for at least 90% of the roofing granules having a major aspect ratio of at least 4the major axis and the minor axis are disposed within 10 degrees of parallel to the major plane of roofing product.

Moreover, even if most of the granules are oriented substantially parallel to the major plane of the roofing products, if there are significant numbers of the granules that are not oriented substantially parallel to the surface, they can undesirably increase surface roughness. Accordingly, in certain embodiments as otherwise described herein, no more than 30% of granules (e.g., no more than 20% or even no more than 10%) having a major aspect ratio of at least 4 are disposed with their major axis or minor axis disposed more than 40 degrees from parallel to the major plane of the roofing product. In certain such embodiments, no more than 30% of granules (e.g., no more than 20% or even no more than 10%) having a major aspect ratio of at least 4 are disposed with their major axis or minor axis disposed more than 30 degrees from parallel to the major plane of the roofing product. In certain such embodiments, no more than 30% of granules (e.g., no more than 20% or even no more than 10%) having a major aspect ratio of at least 4 are disposed with their major axis or minor axis disposed more than 20 degrees from parallel to the major plane of the roofing product. And in certain embodiments, no more than 10% (e.g., no more than 5%) of the granules having a major aspect ratio of at least 4 are disposed with their major axis or minor axis disposed more than 70 degrees from parallel to the major plane of the roofing product. In certain embodiments, no more than 10% (e.g., no more than 5%) of the granules having a major aspect ratio of at least 4 are disposed with their major axis or minor axis disposed more than 60 degrees from parallel to the major plane of the roofing product. In certain embodiments, no more than 10% (e.g., no more than 5%) of the granules having a major aspect ratio of at least 4 are disposed with their major axis or minor axis disposed more than 50 degrees from parallel to the major plane of the roofing product.

As noted above, the solar-reflective roofing granules of the collection substantially coat the top surface of the bituminous material in a region thereof. In certain embodiments, the roofing product has a bituminous area fraction of no more than 10% in the region substantially coated by the solar-reflective roofing granules of the collection. For example, in certain embodiments, the roofing product has a bituminous area fraction of no more than 5%, no more than 3%, or no more than 2%, on the solar-reflective roofing granule-coated top surface of the bituminous material. The bituminous area fraction is the area fraction in which bituminous material is visible, e.g., between the areas occluded by the granules. Bituminous area fraction can be determined via conventional image processing methods.

The present inventors have determined that using granules of relatively large size as described elsewhere herein can provide for a reduction in solar reflectivity by providing a relatively low boundary concentration. As used herein, a boundary concentration is the number of interfaces between granules per unit area. A roofing membrane covered with small particles will have more granule interfaces per unit area than a roofing membrane covered with large particles at the same % bituminous area fraction. Boundary concentration is measured by the procedure described in the example below. For example, in certain embodiments, the boundary concentration is no more than 3.0%, e.g., no more than 2.5% or even no more than 2.0%.

Notably, the present inventors have determined that the surface roughness of the overall roofing product has a significant effect on solar reflectivity of the product. In certain desirable embodiments, a roofing product as otherwise described herein has a surface roughness (Sq) of no more than 350 μm, e.g., no more than 300 μm or even no more than 250 μm, as measured by optical profilometry (e.g., laser triangulation, interferometry, or chromatic confocal profilometry).

Use of the roofing granules as described herein, e.g., oriented as described herein, can provide solar-reflective roofing products with high solar reflectivity. In certain embodiments as otherwise described herein, a roofing product has a solar reflectivity of no less than 60%, e.g., no less than 62% or no less than 64%. Solar reflectivity of a roofing product is determined using a solar reflectometer pursuant to ASTM C1549.

A variety of methods can be used to fabricate the roofing products described herein. For example, conventional granule-dropping methods can be used, especially when the bituminous surface is sufficiently soft that a pressing operation can tilt the granules into the desirable orientation.

The present inventors have noted, however, even when soft a bituminous material can be very sticky, meaning that a pressing operation may not be effective in in some cases in providing the most desired orientations of granules. Thus, the present inventors note that the provision of roofing products with flat granules with both high coverage and an orientation substantially parallel to the roofing product surface can be difficult, and have invented a convenient method for providing such a roofing product. Accordingly, another aspect of the disclosure is a method for making a roofing product as described herein. The method includes providing a substrate having a bituminous material disposed thereon, the bituminous material having a top surface, the top surface of the bituminous material being in a softened state. Also provided is a collection of solar-reflective roofing granules as described herein. The solar-reflective roofing granules of the collection are oriented in a substantially single layer on a substantially upward-facing first, non-adhesive surface having a major plane such that for at least 90% of the roofing granules the major axis and the minor axis are disposed within 20 degrees of parallel (e.g., within 10 degrees of parallel) to the major plane of the first non-adhesive surface. Then, the solar-reflective roofing granules of the collection so oriented are transferred to the top surface of the softened bituminous material without substantially changing their orientation.

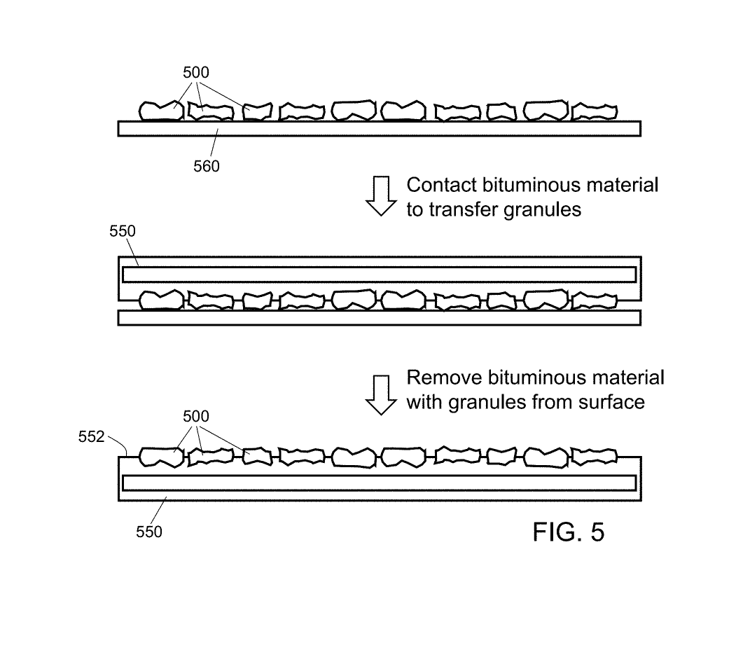

One such embodiment is shown in schematic view in FIG. 5. In the embodiment of FIG. 5, solar reflective roofing granules 500 are oriented in a substantially single layer on first non-adhesive surface 560, which is facing substantially upward. For example, the first non-adhesive surface can be oriented within 20 degrees of parallel to the ground, e.g., 10 degrees of parallel to the ground. The granules are oriented such that for at least 90% of the roofing granules the major axis and the minor axis are disposed within 20 degrees of parallel to the major plane of the first non-adhesive surface. In certain embodiments, the orienting includes disposing the solar-reflective roofing granules of the collection on the first, non-adhesive surface, and then vibrating (e.g., shaking) the first non-adhesive surface under conditions to cause the solar-reflective roofing granules of the collection to orient in a substantially single layer on the first, non-adhesive surface such that for at least 90% of the roofing granules the major axis and the minor axis are disposed within 20 degrees of parallel to the major plane of the first non-adhesive surface. The person of ordinary skill in the art can determine vibrating conditions to provide the desired orientation for a given collection of particles; for example, various types of shaking motions can cause the granules to orient in a desired fashion through the influence of gravity. The granules are then transferred to the top surface of a softened bituminous material disposed on a substrate without substantially changing their orientation (i.e., at the time of the transfer). In the embodiment of FIG. 5, the transfer includes contacting the top surface 552 of a softened bituminous material 550 in a substantially downward-facing orientation against the layer of roofing granules 500 on the first non-adhesive surface, thereby adhering the granules to the top surface of the softened bituminous material. As the person of ordinary skill in the art will appreciate, this can be performed in a variety of ways, e.g., using conveyer belts and continuous processing as is common in the art.

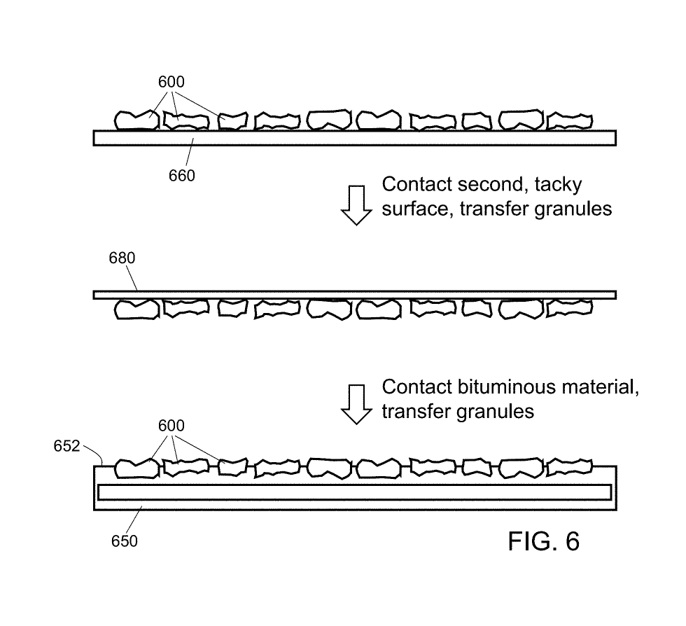

Another method is shown in cross-sectional schematic view in FIG. 6. The method includes bringing a second, tacky surface 680 in a substantially downward-facing orientation against the layer of roofing granules 600 on the first non-adhesive surface 660, thereby adhering the oriented granules to the tacky surface, contacting the top surface 652 of the softened bituminous material 650 with the layer of roofing granules on the second tacky surface, thereby transferring the granules from the second tacky surface to the top surface of the softened bituminous material.

The present inventors have noted above that it can be desirable to include a proportion of smaller granules on the surface of a roofing product, so that they can fill gaps between larger roofing granules. These smaller granules can have a high aspect ratio as described above. But in other embodiments, the smaller granules need not have a high aspect ratio. Thus, a roofing product can be provided as otherwise described herein, with two types of granules disposed on its top surface: the granules of a collection of granules as otherwise described herein; and a second set of granules having a particle size smaller than #30 mesh. The second set of granules can fill in gaps between the larger granules of the collection. The granules of the collection of granules as otherwise described herein desirably forms at least 70 wt % (e.g., at least 80 wt %) of the total granular material on the granule-coated top surface of one or more zones (e.g., one or more exposure zones) of the roofing product. The second set of granules is desirably solar reflective as described above for the collections of roofing granules, although they need not have the high aspect ratio as described above. A two-step method can be used to make such roofing products. First, the granules of a collection as described herein can be disposed on the bituminous material (e.g., using a method as described above), then the granules of the second set can be applied to fill in any gaps between the granules of the collection.

Another aspect of the disclosure is a method for making a collection of solar-reflective roofing granules as described herein. The method includes providing a formable fireable preceramic material forming the preceramic material into a collection of wet preceramic particles having a high aspect ratio; and drying and firing the collection of wet preceramic particles to provide a collection of granular particles having a high aspect ratio. As described in more detail below, these particles can be further coated to provide roofing granules as described herein, or in other embodiments can themselves be suitable for use as roofing granules as described herein.

The person of ordinary skill in the art will appreciate that a variety of formable fireable preceramic materials can be used to form the granular particles described herein. The materials described above with respect to synthetic granules and synthetic granule cores can be used, for example. And the person of ordinary skill in the art will appreciate that a variety of other preceramic materials, e.g., based on clays or other ceramic systems, can be used. The formable material can be, for example, moistened with water or some other suitable liquid to provide formability. A polymeric binder can also or alternatively be used as is common in the ceramic arts; such a binder can soften under pressure to bind the particles, then be burned away during firing. Of course, for some compositions, no liquid or organic binder is necessary to provide formability under pressure.

The formable fireable preceramic material can be formed into a collection of wet preceramic particles having a high aspect ratio. A variety of forming techniques can be used. For example, the preceramic material can be extruded into a thin ribbon or sheet, then cut or broken into shapes with a desired aspect ratio. For example, a cutter disposed at the output of an extruder can be used to cut the ribbon or sheet of preceramic material into the desired shapes.

In one especially desirable embodiment, the forming of the material is performed by roll compaction. Roll compaction can be used to form a thin sheet of material, which can then be cut or broken into particles of the desired shape. In other embodiments, at least one roll of the roll compactor has a mold surface formed thereon. The mold surface of the roll compactor can be configured to form desired high aspect ratio shapes from the material. In certain embodiments, the mold surface is configured to form granules all having substantially similar shapes. Such granules can be suitable, for example, for commercial roofing applications, in which aesthetic considerations are less important. However, in other embodiments, the mold surface is configured to form granules having a variety of different shapes. The mold surface can provide, e.g., at least four, at least ten, or even at least twenty different shapes. With a larger number of different shapes, the granules can be more suitable for use in residential roofing applications, where a more random appearance is desired. The person of ordinary skill in the art can select roll compaction parameters to provide a collection of preceramic particles that are robust enough to be fired.

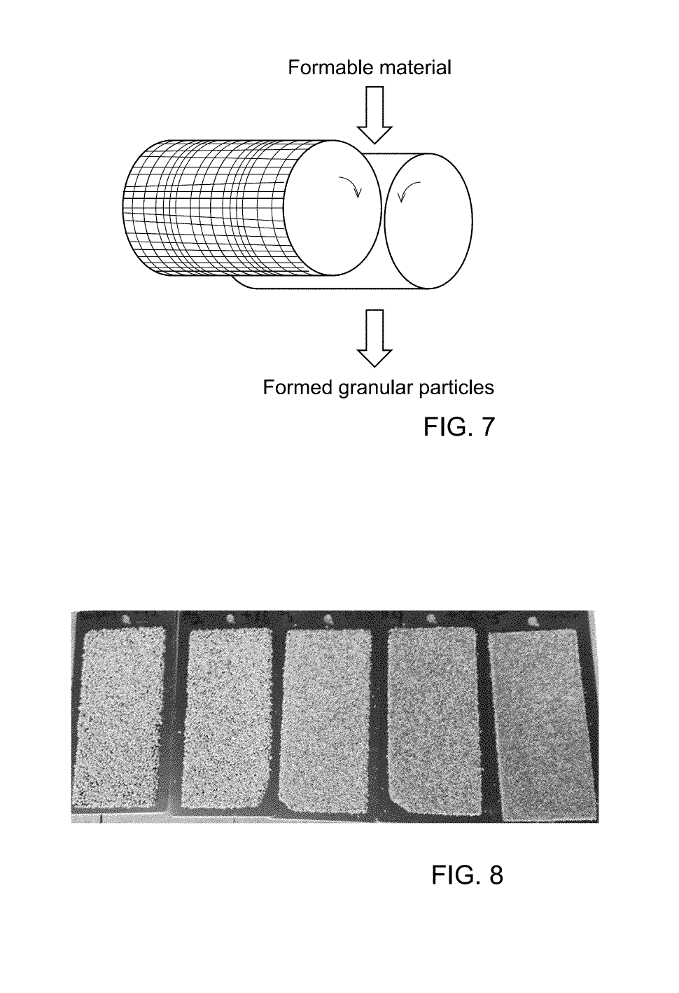

FIG. 7 is a schematic view of a method for using roll compaction to form granular particles

Here, a formable material is passed between two rollers, spaced closely apart at a nip. The left-hand roller has a mold surface formed thereon, configured to form the formable material into granular particles. As the rollers roll, the formable material is flattened between them and cut into granular pieces by the mold surface of the roller.

The method further includes firing the preceramic particles of the collection to provide a collection of granular particles having a high aspect ratio. The person of ordinary skill will select firing conditions (e.g., with any desirable drying steps) to provide robust granular particles.

The dimensions of the particles can be provided to provide a desired shape and size to the granules of the final collection of roofing granules (e.g., after any coating or other operations). The aspect ratios and sizes described above with respect to the roofing granules can likewise be selected from the granular particles made by the methods described herein.

The granular particles themselves can be used as a base particle to make the coated granules described above. Thus, in certain embodiments, the method further includes coating the high aspect ratio particles of the collection with a coating, such as a solar-reflective coating as described above. The coating can be performed on the fired particles, or alternatively can be performed on the preceramic particles with a preceramic coating, with the firing serving to fire both the material of the particles and the material of the coating.

In other embodiments, the granular particles can themselves be the solar-reflective roofing granules. Of course, as described above, other thin coatings can be formed thereon (e.g., silane or siloxane coatings).

The following non-limiting examples serve to further explain the roofing granules, roofing products and methods of the disclosure.

### Granule Size

A set of granule packing experiments was designed to determine the effect of granule size on coverage and appearance. A sieve separation was conducted to separate a sample of commercial white granules into the fractions shown in Table 1, below

TABLE 1

| US Sieve Range | Wt % of total |
|---|---|
| +12 | 8% |
| 12\16 | 43% |
| 16/20 | 27% |
| 20/30 | 18% |
| 30/40 | 4% |
| −40 | negligible |

Shinglets were made from each fraction and two granule blends as shown in Table 2, below, using conventional granule application methods on small asphalt-coated substrates. The color (L*, a* and b*), Solar Reflectivity (SR), and coverage (% black) were measured and are also listed in Table 2. L*, a*, b* and SR are the average of three measurements. % black is calculated from the measured asphalt exposed over 12 measurements across the shinglet surface (the old % coverage method).

TABLE 2

| Sample | Sieve | | | | | % black | |
|---|---|---|---|---|---|---|---|
| no. | size | L* | a* | b* | SR | Average | stdev |
| 1 | +12 | 81.12 | −0.17 | 2.87 | 0.572 | 14.8 | 1.5 |
| 2 | 12\16 | 81.92 | −0.06 | 3.34 | 0.587 | 15.0 | 1.5 |
| 3 | 16/20 | 79.81 | 0.09 | 3.91 | 0.557 | 17.9 | 2.1 |
| 4 | 20/30 | 84.74 | −0.36 | 2.67 | 0.615 | 12.6 | 0.4 |
| 5 | 30/40 | 80.16 | −0.12 | 3.49 | 0.542 | 16.7 | 1.1 |
| 6 | 50/50 12/16 + | 80.89 | 0.04 | 3.83 | 0.565 | 15.7 | 1.6 |
| | 16/20 | | | | | | |
| 7 | 50/50 12/16 + | 76.7 | 0.32 | 4.49 | 0.520 | 25.1 | 3.4 |
| | 30/40 | | | | | | |

The data presented in Table 2 appear to demonstrate an effect of particle size on SR and color. Surprisingly, the 20/30 sample delivered a higher SR and a lighter color.

The SR measurements presented in Table 2 were obtained within two days of making the shinglets. At this point, all of the granules appeared white. After one month of aging in laboratory conditions under room lighting at room temperature, however, the granules became stained. The staining is shown in the photographs of FIG. 8, for samples 1-5 (in which the left-most sample is the most white, with increasing color moving right). This is a known problem for white granules placed on top of modified asphalt, as low molecular weight compounds from the asphalt diffuse into the oil on the granules. One surprising result, however, was how much more severe the staining was for smaller granules when compared to larger ones.

Additional shingle samples were made from blends of 20/30 granules and 30/40 granules, as well as from 20/30 granules and 30/40 granules alone. Data for these samples is shown in Table 3, below:

TABLE 3

| Granule | | | | Shingle | | | |
|---|---|---|---|---|---|---|---|
| % | % | Median | | % | % | Sₐ | |
| 20/30 | 30/40 | (μm) | Span | asphalt | boundaries | (μm) | SR |
| 0 | 1 | 608 | 0.50 | 17.1 | 4.29 | 229 | 0.516 |
| 0.2 | 0.8 | 641 | 0.61 | 16.8 | 4.18 | 230 | 0.521 |
| 0.5 | 0.5 | 709 | 0.65 | 13.9 | 3.84 | 235 | 0.551 |
| 0.8 | 0.2 | 786 | 0.58 | 16.0 | 3.72 | 273 | 0.552 |
| 1 | 0 | 826 | 0.49 | 17.0 | 3.43 | 327 | 0.561 |

The data indicate that SR decreases as particle size decreases (a higher percentage of 30/40 granules are added to the blend). There was no change in coating thickness or exposed asphalt to explain this behavior. Furthermore, the surface roughness decreases with decreasing particle size, a trend that in isolation should increase the SR. Therefore, it is concluded for this data set the SR is dominated by the boundary concentration. A higher number of small particles in the granule distribution results in a higher number of boundary locations in which light can become trapped.

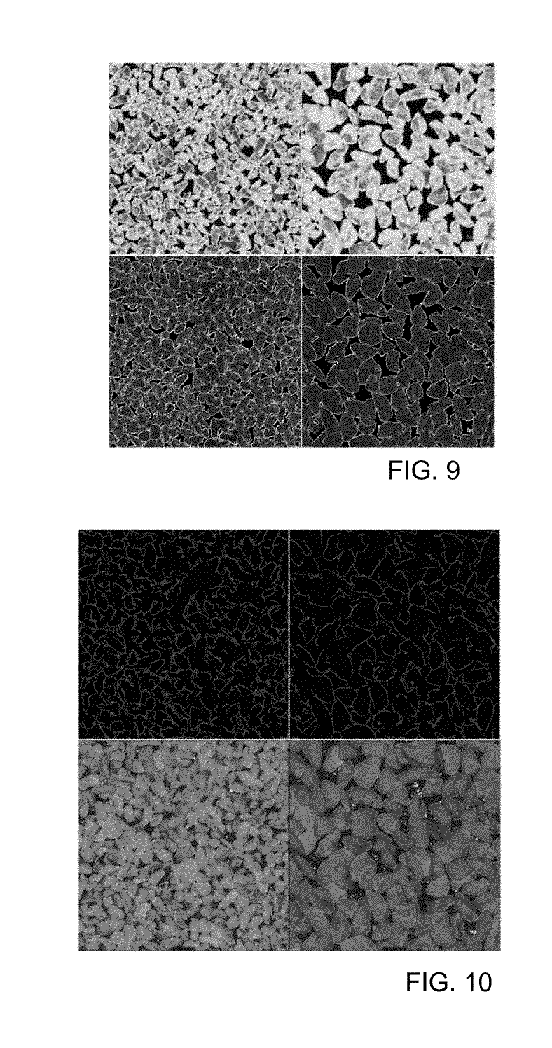

Boundary concentration was determined by quantifying the magnitudes in the grayscale gradient variations of images taken of the samples. Essentially, the idea was based on the fact that in areas where there is light-trapping, i.e. granule boundaries, there is a perceived localized discontinuation that is translated into a variation in the grayscale value in each color plane. Hence, if the most significant gradient variations could be isolated, it was envisaged that this would give an indication as to the level significance of granule boundaries that are present. It was hypothesized these grain boundaries played a significant role in light trapping. A typical example can be seen in FIG. 9, which is a set of images showing grayscale value intensity variations, and the accompanying gradient magnitude map for 30/40 granules (left images) and 16/20 granules (right images). The top set of images is a false-color rendering of the grayscale values. The second set of images show the rate of change of the localized grayscale values, following the application of a Sobel edge amplification algorithm.

What can be observed in the bottom set of images in FIG. 9 is the level of light interaction in the boundaries. Extensive morphological operations were performed to obtain a set of boundary skins shown in FIG. 10, along with a second set of superimposed images shown in the second row. It can be seen from FIG. 10 that the granule boundaries are substantially identified. It is clear from FIG. 10 that the sample made from smaller granules (left side) has more boundaries per unit area than the sample made from large granules (right side). The area fraction of boundaries identified by this method is used for comparison across the various samples.

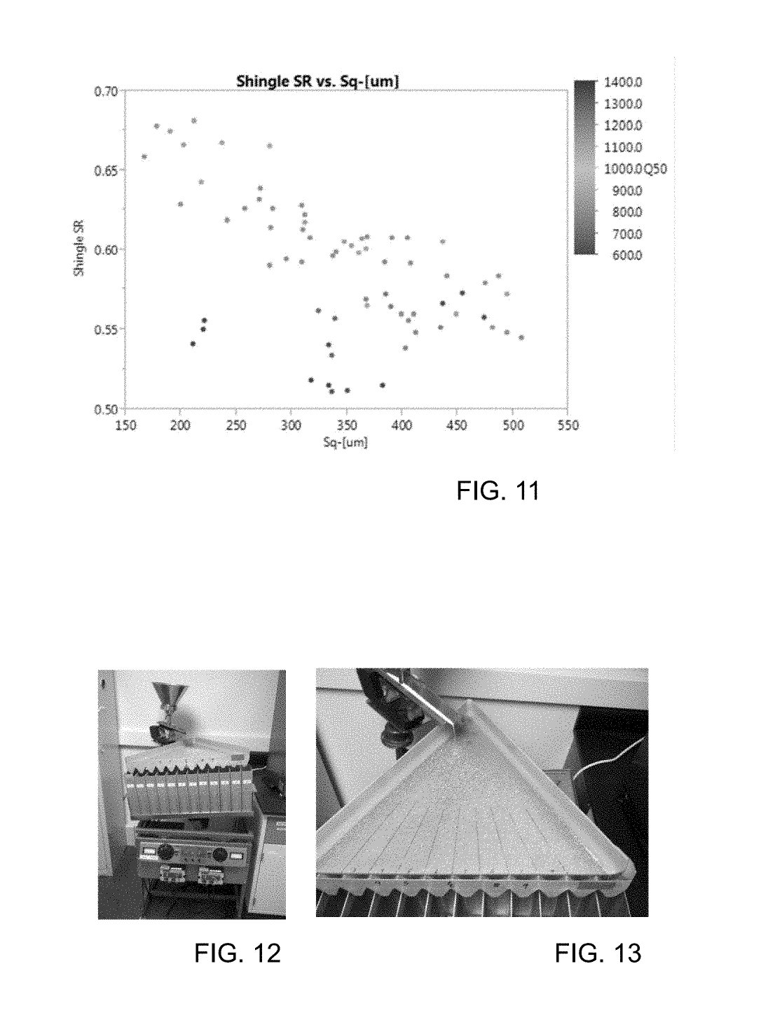

Shingle solar reflectivities were measured for a variety of shingles made from sorted commercial white granules. FIG. 11 correlates SR with measured shingle roughness (Sa) as measured by optical profilometry and median granule particle size (Q50). The data demonstrate that for a given surface roughness, shingles with smaller particle sizes have lower SR values.

### Granule Shape

In addition to the granule size, we also expect the granule shape to affect the appearance and SR of the shingles. A vibratory shape sorter (FIG. 12, full view; FIG. 13, view of sorting table with white roofing granules separating over the table) was used to separate the granules by shape. While traveling over the vibrating table, the rounder granules are more likely to roll and segregate to the lower numbered bins (left side of the table). The more angular granules are more likely to slide and tumble and segregate to the higher numbered bins (right side of the table).

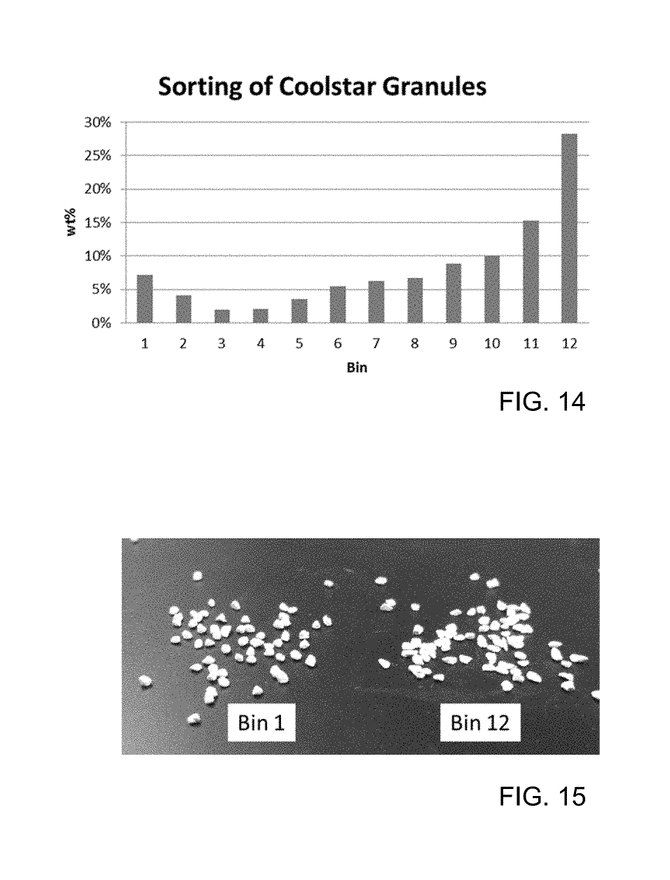

The distribution of granules (by weight) in each bin at the end of sorting is shown in FIG. 14. The table conditions (table angles, vibration amplitude, and feed rate) can be adjusted to change this distribution to be flatter or closer to normal. Visual inspection indicated that that the granules in bin 1 are rounder in shape while those in bin 12 are flakey (see the pictures of FIG. 15). The granules in the intermediate bins have intermediate shapes.

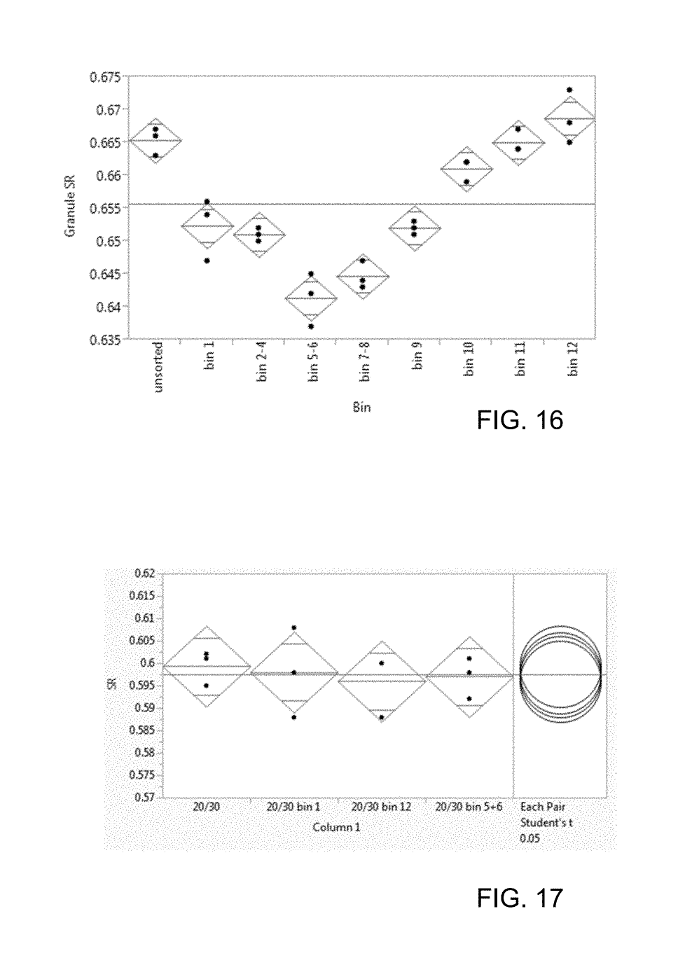

The solar reflectivity of the granules were evaluated in a petri dish using a portable reflectometer. There were not enough granules in some bins to sufficiently fill the dish (for example bins 2-4), so these bins were combined. The solar reflectivity of the granules was found to vary across the table as shown in FIG. 16. The center of each diamond represents the mean, with lines above and below the centerline representing the 95% confidence interval. The data in FIG. 12 can be divided into three reflectivity groupings. The lowest reflectivities come from bins 5-8, medium reflectivity from bins 1-4 and bin 9, and higher reflectivities from bins 10-12. The differences in reflectivity are likely a result of packing in the petri dish. For this measurement, the granules are poured into a glass petri dish, and the bottom of a second glass petri dish is used to tap the top surface flat. When bins 10-12 were subject to this tapping, the flaky granules laid down to produce a relatively flat surface with minimal light trapping. The rounder granules (bins 1-4) were not able to produce a relatively flat surface upon tapping.

Granules from certain bins were pressed onto black plastic tapes to approximate shingles. The solar reflectivities (SR) of these test samples were measured and are shown in FIG. 17. The solar reflectivity was found to be equivalent for tape shingles made from the different granules. This was a surprising result, in light of the differences in granule SR shown in FIG. 17. However, the granule orientation was not controlled on these tape samples. Even though the granules are pressed into the shingle, they are constrained by the sticky tape (mimicking the asphalt in many conventional shingle coating methods) and are not able to rotate as they are when packed into the petri dish. This was attempted both using the black tape as well as pressing the granules directly into asphalt patties. In both cases, a difference in SR was not observed between granules from different bins.

### Granule Orientation

Typically, test shingles are made by placing an asphalt patty or black tape face up and pouring the granules onto the tape. A roller is then used to press the granules into the tape. This approximates conventional granule coating processes used in manufacturing of roofing products. The orientation is not controlled during the standard process, so the granule orientation is considered to be substantially random.

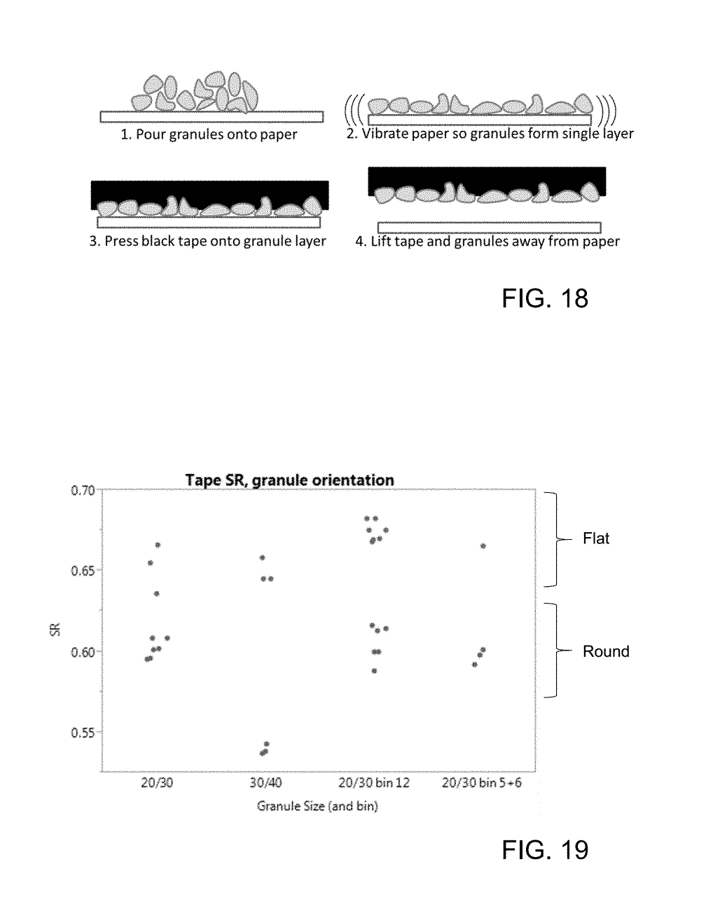

A different set of tape samples were made with granules oriented parallel to the tape surface or “flattened”, using the method shown in FIG. 18.

The SR was measured for tape samples made with random and flattened granule orientations and the results are shown in FIG. 19. The SR is higher for all samples with flat orientation. The inventors surmise that a higher measured SR results when the surface roughness is lower and so the probability that a reflected ray will hit another granule is smaller. For the flakey granules (20/30 bin 12) we find the increase in SR to be approximately 7 points, bringing the average SR from 60.5 to 67.4.

Additional aspects of the disclosure are provided by the following enumerated embodiments, which can be combined and permuted in any number and in any combination that is not technically or logically inconsistent.

### Embodiment 1

A collection of solar-reflective roofing granules having a solar reflectivity of at least 70%, at least 70 wt % (e.g., at least 80 wt % or at least 90 wt %) of the solar-reflective roofing granules of the collection having a major aspect ratio of at least 4 and a minor aspect ratio of at least 3.

### Embodiment 2

The collection of solar-reflective roofing granules according to claim 1, wherein at least 70 wt % (e.g., at least 80 wt % or at least 90 wt %) of the solar-reflective roofing granules of the collection have a major aspect ratio of at least 6, e.g., at least 8.

### Embodiment 3

The collection of solar-reflective roofing granules according to claim 2, wherein at least 70 wt % (e.g., at least 80 wt % or at least 90 wt %) of the solar-reflective roofing granules of the collection have a minor aspect ratio of at least 5, e.g., at least 7.

### Embodiment 4

The collection of solar-reflective roofing granules according to any of claims 1-3, wherein in at least 70 wt % (e.g., at least 80 wt % or at least 90 wt %) of the solar-reflective roofing granules of the collection the ratio of the major axis to the minor axis is in the range of 1-2.

### Embodiment 5

The collection of solar-reflective roofing granules according to any of claims 1-3, wherein in at least 70 wt % (e.g., at least 80 wt % or at least 90 wt %) of the solar-reflective roofing granules of the collection the ratio of the major axis to the minor axis is 1-1.5, or in the range of 1-1.33.

### Embodiment 6

The collection of solar-reflective roofing granules according to any of claims 1-5, wherein at least 90 wt % of the solar-reflective roofing granules of the collection have a particle size in the range of ¼″ US mesh to #50 US mesh, e.g., #5 US mesh to #50 US mesh.

### Embodiment 7

The collection of solar-reflective roofing granules according to any of claims 1-6, wherein at least 50 wt % (e.g., at least 70 wt %, at least 80 wt % or at least 90 wt %) of the solar-reflective roofing granules have a particle size in the range of ¼″ US mesh to #30 US mesh, for example, ¼″ US mesh to #25 US mesh, #5 US mesh to 30 US mesh, or #5 US mesh to #25 US mesh.

### Embodiment 8

The collection of solar-reflective roofing granules according to any of claims 1-6, wherein at least 50 wt % (e.g., at least 70 wt %, at least 80 wt % or even at least 90 wt %) of the solar-reflective roofing granules have a particle size in the range of ¼″ US mesh to #20 US mesh, for example, #5 US mesh to 20 US mesh, ¼″ US mesh to 15 US mesh, #5 US mesh to #15 US mesh or #10 US mesh to #20 US mesh.

### Embodiment 9

The collection of solar-reflective roofing granules according to any of claims 1-6, wherein at least 50 wt % (e.g., at least 70 wt %, at least 80 wt % or even at least 90 wt %) of the solar-reflective roofing granules have a particle size in the range of #12 US mesh to #20 US mesh, for example, #16 US mesh to #20 US mesh.

### Embodiment 10

The collection of solar-reflective roofing granules according to any of claims 1-9, wherein at least 10% by weight (e.g., at least 15 wt %, at least 20 wt %, or even at least 30 wt %) of the granules of the collection have a particle size in excess of #20 mesh (e.g., in excess of #30 mesh).

### Embodiment 11

The collection of solar-reflective roofing granules according to any of claims 1-10, having a solar reflectivity of at least 75%, at least 80%, or even at least 85%.

### Embodiment 12

The collection of solar-reflective roofing granules according to any of claims 1-11, wherein the solar-reflective roofing granules of the collection substantially comprise a base particle having a solar-reflective coating disposed thereon.

### Embodiment 13

The collection of solar-reflective roofing granules according to claim 12, wherein the base particle is crushed slate, slate granules, shale granules, mica granules, metal flakes.

### Embodiment 14

The collection of solar-reflective roofing granules according to claim 12, wherein the base particle is a synthetic particle.

### Embodiment 15

The collection of solar-reflective roofing granules according to any of claims 12-14, wherein the coating comprises a coating binder and a solar reflective pigment.

### Embodiment 16

The collection of solar-reflective roofing granules according to claim 15, wherein the coating binder is selected from the group consisting of metal silicates, fluoropolymers, metal phosphates, silica coating binders, sol-gel coating binders, polysiloxanes, silicones, polyurethanes, and polyacrylates.

### Embodiment 17

The collection of solar-reflective roofing granules according to claim 15 or claim 16, wherein the solar-reflective pigment is selected from the group consisting of titanium dioxide, calcium carbonate, zinc oxide, lithopone, zinc sulphide, white lead, glass microspheres, glass microbubbles, microvoid pigments, and synthetic polymeric opacifiers

### Embodiment 18

The collection of solar-reflective roofing granules according to any of claims 12-14, wherein the solar-reflective coating comprises an aluminosilicate clay.

### Embodiment 19

The collection of solar-reflective roofing granules according to any of claims 1-11, wherein the solar-reflective roofing granules of the collection substantially are formed from a single composition.

### Embodiment 20

The collection of solar-reflective roofing granules according to any of claims 1-19, the collection of solar-reflective roofing granules is white in color, and has (a*²+b*²)^{1/2} less than 6.

### Embodiment 21

A roofing product comprising
a substrate;
a bituminous material coated on the substrate, the bituminous material having a top surface; and
the collection of solar-reflective roofing granules according to any of claims 1-20 disposed on the top surface of the bituminous material, thereby substantially coating the bituminous material in a region thereof.

### Embodiment 22

The roofing product according to claim 21, in the form of a roofing shingle.

### Embodiment 23

The roofing product according to claim 21, in the form of a roofing membrane.

### Embodiment 24

The roofing product according to any of claims 21-23, the roofing product having a major plane, wherein each roofing granule has a major axis, a minor axis perpendicular to the major axis, and a thickness, and wherein for at least 90% of the roofing granules having a major aspect ratio of at least 4 the major axis and the minor axis are disposed within 20 degrees of parallel to the major plane of the roofing product.

### Embodiment 25

The roofing product according to any of claims 21-23, the roofing product having a major plane, wherein each roofing granule has a major axis, a minor axis perpendicular to the major axis, and a thickness, and wherein for at least 90% of the roofing granules having a major aspect ratio of at least 4 the major axis and the minor axis are disposed within 10 degrees of parallel to the major plane of the roofing product.

### Embodiment 26

The roofing product according to any of claims 21-25, wherein no more than 30% of granules (e.g., no more than 20% or even no more than 10%) having a major aspect ratio of at least 4 are disposed with their major axis or minor axis disposed more than 40 degrees (e.g., no more than 30 degrees or even no more than 20 degrees) from parallel to the major plane of the roofing product.

### Embodiment 27

The roofing product according to any of claims 21-26, wherein no more than 10% (e.g., no more than 5%) of the granules having a major aspect ratio of at least 4 are disposed with their major axis or minor axis disposed more than 70 degrees (e.g., more than 60 degrees or more than 50 degrees) from parallel to the major plane of the roofing product.

### Embodiment 28

The roofing product according to any of claims 21-27, wherein the roofing product has a bituminous area fraction of no more than 10% in the region substantially coated by the solar-reflective roofing granules of the collection.

### Embodiment 29

The roofing product according to any of claims 21-28, wherein the roofing product has a bituminous area fraction of no more than 5%, no more than 3%, or no more than 2% in the region substantially coated by the solar-reflective roofing granules of the collection.

### Embodiment 30

The roofing product according to any of claims 21-29, having a boundary concentration of no more than 3.0%, e.g., no more than 2.5% or even no more than 2.0%.

### Embodiment 31

The roofing product according to any of claims 21-30, having a surface roughness (Sq) of no more than 350 μm, e.g., no more than 300 μm or even no more than 250 μm.

### Embodiment 32

The roofing product according to any of claims 21-31, having a solar reflectivity of no less than 60%, e.g., at least 62% or at least 64%.

### Embodiment 33

A method for making a roofing product according to any of claims 21-32, comprising
providing a substrate having a bituminous material disposed thereon, the bituminous material having a top surface, the top surface of the bituminous material being in a softened state; and
providing a collection of solar-reflective roofing granules according to any of claims 1-20;
orienting the solar-reflective roofing granules of the collection in a substantially single layer on a substantially upward-facing first, non-adhesive surface having a major plane such that for at least 90% of the roofing granules the major axis and the minor axis are disposed within 20 degrees of parallel to the major plane of the first non-adhesive surface; and then
transferring the solar-reflective roofing granules of the collection to the top surface of the softened bituminous material without substantially changing the orientation of the solar-reflective roofing granules of the collection.

### Embodiment 34

The method according to claim 33, wherein the orienting includes disposing the solar-reflective roofing granules of the collection on the first, non-adhesive surface, and then vibrating the first non-adhesive surface under conditions to cause the solar-reflective roofing granules of the collection to orient in a substantially single layer on the first, non-adhesive surface such that for at least 90% of the roofing granules the major axis and the minor axis are disposed within 20 degrees of parallel to the major plane of the first non-adhesive surface.

### Embodiment 35

The method according to claim 33 or claim 34, wherein the transferring includes contacting the top surface of the softened bituminous material in a substantially downward-facing orientation against the layer of roofing granules on the first non-adhesive surface, thereby adhering the granules to the top surface of the softened bituminous material.

### Embodiment 36

The method according to claim 33 or claim 34, wherein the transferring includes bringing a second, tacky surface in a substantially downward-facing orientation against the layer of roofing granules on the first non-adhesive surface, thereby adhering the granules to the tacky surface, contacting the top surface of the softened bituminous material with the layer of roofing granules on the second tacky surface, thereby transferring the granules from the second tacky surface to the top surface of the softened bituminous material.

### Embodiment 37

A method for making a collection of solar-reflective roofing granules according to any of claims 1-20, the method comprising
providing a formable fireable preceramic material;
forming the preceramic material into a collection of preceramic particles having a high aspect ratio; and
firing the collection of preceramic particles to provide a collection of granular particles having a high aspect ratio.

### Embodiment 38

The method according to claim 37, wherein the forming is performed by roll compaction.

### Embodiment 39

The method according to claim 38, wherein the roll compactor includes a mold surface formed on one or more rolls thereof, the mold surface being configured to form high aspect ratio shapes from the material.

### Embodiment 40

The method according to claim 39, wherein the mold surface provides at least four different shapes.

### Embodiment 41

The method according to claim 37, wherein the forming is performed by extrusion.

### Embodiment 42

The method according to any of claims 37-41 further comprising coating the high aspect ratio particles of the collection with a coating, e.g., a solar-reflective coating.

### Embodiment 43

The method according to any of claims 37-41, further comprising coating the collection of wet preceramic particles with a preceramic coating before firing the collection.

### Embodiment 44

The method according to any of claims 37-41, wherein the solar-reflective roofing granules of the collection substantially are formed from a single composition.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

What is claimed is:

1. A collection of solar-reflective roofing granules having a solar reflectivity of at least 70% of the solar-reflective roofing granules of the collection having a major aspect ratio of at least 4 and a minor aspect ratio of at least 3.

2. The collection of solar-reflective roofing granules according to claim 1, wherein in at least 70 wt % of the solar-reflective roofing granules of the collection the ratio of the major axis to the minor axis is in the range of 1-2.

3. The collection of solar-reflective roofing granules according to claim 1, wherein at least 90 wt % of the solar-reflective roofing granules of the collection have a particle size in the range of ¼″ US mesh to #50 US mesh.

4. The collection of solar-reflective roofing granules according to claim 1, wherein at least 50 wt % of the solar-reflective roofing granules have a particle size in the range of ¼″ US mesh to #30 US mesh.

5. The collection of solar-reflective roofing granules according to claim 1, wherein at least 10% by weight of the granules of the collection have a particle size in excess of #20 mesh.

6. The collection of solar-reflective roofing granules according to claim 1, having a solar reflectivity of at least 75%.

7. The collection of solar-reflective roofing granules according to claim 1, wherein the solar-reflective roofing granules of the collection substantially comprise a base particle having a solar-reflective coating disposed thereon.

8. The collection of solar-reflective roofing granules according to claim 1, wherein the collection of solar-reflective roofing granules is white in color; and has (a*²+b*²)^{1/2} less than 6.

9. A roofing product comprising
a substrate;
a bituminous material coated on the substrate, the bituminous material having a top surface; and
the collection of solar-reflective roofing granules according to claim 1 disposed on the top surface of the bituminous material, thereby substantially coating the bituminous material in a region thereof.

10. The roofing product according to claim 9, the roofing product having a major plane, wherein each roofing granule has a major axis, a minor axis perpendicular to the major axis, and a thickness, and wherein for at least 90% of the roofing granules having a major aspect ratio of at least 4 the major axis and the minor axis are disposed within 20 degrees of parallel to the major plane of the roofing product.

11. The roofing product according to claim 9, wherein no more than 30% of granules having a major aspect ratio of at least 4 are disposed with their major axis or minor axis disposed more than 40 degrees from parallel to the major plane of the roofing product.

12. The roofing product according to claim 9, wherein no more than 10% of the granules having a major aspect ratio of at least 4 are disposed with their major axis or minor axis disposed more than 70 degrees from parallel to the major plane of the roofing product.

13. The roofing product according to claim 9, wherein the roofing product has a bituminous area fraction of no more than 10% in the region substantially coated by the solar-reflective roofing granules of the collection.

14. A method for making a roofing product comprising
a substrate;
a bituminous material coated on the substrate, the bituminous material having a top surface; and
the collection of solar-reflective roofing granules according to claim 1 disposed on the top surface of the bituminous material, thereby substantially coating the bituminous material in a region thereof,
the method comprising
providing a substrate having a bituminous material disposed thereon, the bituminous material having a top surface, the top surface of the bituminous material being in a softened state; and
providing the collection of solar-reflective roofing granules according to claim 1;
orienting the solar-reflective roofing granules of the collection in a substantially single layer on a substantially upward-facing first, non-adhesive surface having a major plane such that for at least 90% of the roofing granules the major axis and the minor axis are disposed within 20 degrees of parallel to the major plane of the first non-adhesive surface; and then
transferring the solar-reflective roofing granules of the collection to the top surface of the softened bituminous material without substantially changing the orientation of the solar-reflective roofing granules of the collection.

15. The method according to claim 14, wherein the orienting includes disposing the solar-reflective roofing granules of the collection on the first, non-adhesive surface, and then vibrating the first non-adhesive surface under conditions to cause the solar-reflective roofing granules of the collection to orient in a substantially single layer on the first, non-adhesive surface such that for at least 90% of the roofing granules the major axis and the minor axis are disposed within 20 degrees of parallel to the major plane of the first non-adhesive surface.

16. The method according to claim 14, wherein the transferring includes contacting the top surface of the softened bituminous material in a substantially downward-facing orientation against the layer of roofing granules on the first non-adhesive surface, thereby adhering the granules to the top surface of the softened bituminous material.

17. A method for making a collection of solar-reflective roofing granules according to claim 1, the method comprising
providing a formable fireable preceramic material;
forming the preceramic material into a collection of preceramic particles having a high aspect ratio; and
firing the collection of preceramic particles to provide a collection of granular particles having a high aspect ratio.

18. The method according to claim 17, wherein the forming is performed by roll compaction.

19. The method according to claim 18, wherein the roll compactor includes a mold surface formed on one or more rolls thereof, the mold surface being configured to form high aspect ratio shapes from the material.
